(19) United States
(12) Patent Application Publication
(10) Pub. No.: US 2011/0240755 A1
(43) Pub. Date: Oct. 6, 2011

(54) God forms' Genres

(76) Inventor: Svetozar B. Petrovich, Chicago, IL (US)

(21) Appl. No.: 13/068,587

(22) Filed: May 16, 2011

Related U.S. Application Data
(63) Continuation-in-part of application No. 12/658,099, filed on Feb. 1, 2010, now abandoned.
Application No. 12/658,099 is a continuation-in-part of application No. PCT/US2010/001379, filed on May 10, 2010.
Application No. PCT/US2010/001379 is a continuation-in-part of application No. PCT/US2010/000187, filed on Jan. 25, 2010.
Application No. PCT/US2010/000187 is a continuation-in-part of application No. PCT/US2010/000188, filed on Jan. 25, 2010.
Application No. PCT/US2010/000188 is a continuation-in-part of application No. 12/453,444, filed on May 12, 2009.
Application No. 12/453,444 is a continuation-in-part of application No. 12/382,448, filed on Mar. 17, 2009, now abandoned.
Application No. 12/382,448 is a continuation-in-part of application No. 12/320,441, filed on Jan. 26, 2009.
Application No. 12/320,441 is a continuation-in-part of application No. 12/320,440, filed on Jan. 26, 2009, now abandoned.
Application No. 12/320,440 is a continuation-in-part of application No. 12/153,036, filed on May 13, 2008.
Application No. 12/153,036 is a continuation-in-part of application No. 11/809,132, filed on May 31, 2007, now abandoned.
Application No. 11/809,132 is a continuation-in-part of application No. 11/807,748, filed on May 30, 2007, now abandoned.
Application No. 11/807,748 is a continuation-in-part of application No. 11/788,172, filed on Jun. 4, 2007, now abandoned.
Application No. 11/788,172 is a continuation-in-part of application No. 11/724,752, filed on Mar. 15, 2007, now abandoned.
Application No. 11/809,132 is a continuation-in-part of application No. 11/807,748, filed on May 30, 2007, now abandoned.
Application No. 11/788,172 is a continuation-in-part of application No. 11/504,304, filed on Aug. 14, 2006, now abandoned.
Application No. 11/504,304 is a continuation-in-part of application No. 11/385,078, filed on Mar. 20, 2006, now abandoned.
Application No. 11/724,752 is a continuation-in-part of application No. 11/418,157, filed on May 3, 2006, now abandoned.
Application No. 11/418,157 is a continuation-in-part of application No. 11/342,006, filed on Jan. 30, 2006, now abandoned.
Application No. 11/342,006 is a continuation-in-part of application No. 11/233,546, filed on Sep. 23, 2005, now abandoned.
Application No. 11/233,546 is a continuation-in-part of application No. 11/212,943, filed on Aug. 25, 2005, now abandoned.
Application No. 11/212,943 is a continuation-in-part of application No. 11/188,339, filed on Jul. 25, 2005, now abandoned.
Application No. 11/188,339 is a continuation-in-part of application No. 11/028,982, filed on Jan. 3, 2005, now abandoned.
Application No. 11/028,982 is a continuation-in-part of application No. 10/869,752, filed on Jun. 16, 2004, now abandoned.
Application No. 10/869,752 is a continuation-in-part of application No. 10/840,152, filed on May 5, 2004, now abandoned.
Application No. 10/840,152 is a continuation-in-part of application No. 10/742,485, filed on Dec. 19, 2003, now abandoned.
Application No. 10/742,485 is a continuation-in-part of application No. 10/190,993, filed on Jul. 8, 2002, now abandoned.
Application No. 10/190,993 is a continuation-in-part of application No. 10/156,192, filed on May 28, 2002, now abandoned.
Application No. 10/156,192 is a continuation-in-part of application No. 10/074,966, filed on Feb. 13, 2002, now abandoned.
Application No. 10/074,966 is a continuation-in-part of application No. 09/850,927, filed on May 8, 2001, now abandoned.
Application No. 09/850,927 is a continuation-in-part of application No. 09/518,884, filed on Mar. 6, 2000, now abandoned.
Application No. 09/518,884 is a continuation-in-part of application No. 09/376,957, filed on Aug. 18, 1999, now abandoned.
Application No. 10/869,752 is a continuation-in-part of application No. 10/840,152, filed on May 5, 2004, now abandoned.
Application No. 10/156,192 is a continuation-in-part of application No. 10/074,966, filed on Feb. 13, 2002, now abandoned.
Application No. 09/850,927 is a continuation-in-part of application No. 09/518,884, filed on Mar. 6, 2000, now abandoned.
Application No. 10/869,752 is a continuation-in-part of application No. 10/195,668, filed on Jul. 15, 2002, now abandoned.
Application No. 10/195,668 is a continuation-in-part of application No. 10/073,914, filed on Feb. 14, 2002, now abandoned.
Application No. 09/850,927 is a continuation-in-part of application No. 09/518,884, filed on Mar. 6, 2000, now abandoned.
Application No. 10/742,485 is a continuation-in-part of application No. 10/156,192, filed on May 28, 2002, now abandoned.
Application No. 10/190,993 is a continuation-in-part of application No. 10/073,914, filed on Feb. 14, 2002, now abandoned.
Application No. 10/074,966 is a continuation-in-part of application No. 09/850,927, filed on May 8, 2001, now abandoned.
Application No. 09/518,884 is a continuation-in-part of application No. 09/376,957, filed on Aug. 18, 1999, now abandoned.
Application No. 09/376,957 is a continuation-in-part of application No. 08/950,898, filed on Oct. 15, 1997, now Pat. No. 5,941,273.
(60) Provisional application No. 60/231,514, filed on Sep. 9, 2000.
(60) Provisional application No. 60/223,750, filed on Aug. 8, 2000.
(60) Provisional application No. 60/220,358, filed on Jul. 24, 2000.
(60) Provisional application No. 60/217,308, filed on Jul. 11, 2000.
(60) Provisional application No. 60/123,504, filed on Mar. 9, 1999.
(60) Provisional application No. 60/123,504, filed on Mar. 9, 1999.
(60) Provisional application No. 60/123,207, filed on Mar. 8, 1999.
(60) Provisional application No. 60/123,153, filed on Mar. 6, 1999.
(60) Provisional application No. 60/123,504, filed on Mar. 9, 1999.
(60) Provisional application No. 60/123,207, filed on Mar. 8, 1999.
(60) Provisional application No. 60/123,153, filed on Mar. 6, 1999.

(51) Int. Cl. A01G 15/00

(52) U.S. Cl. 239/14.1

(57) ABSTRACT

An advanced Processor couples magma and mantle magnetic field functions, couples mantle quanta masses vital groundwater, polar caps and glaciers, and less couples continental waters and oceans, partially decoupling atmosphere, and least coupling the ionosphere and its transiting ions and electrons; said mantle solidified boundaries contain most of Earth internal heat and electrical energy transfers, lessening gaseous fluids boundary distending and Earth's cooling weakening of magnetic field; Fluid Elements mass energy highest conserving (MEHC), and quintessential core natural disposition (QCNDMEHC) functions crucial processes, configure complete compliments sealed boundaries longevity, forms least energy of distortion volume changes, with stratifications gradations and no forbidden mechanisms plasma fountains; fluids composition, optimal diatomic atmosphere, and mass energy MEHC genres embody God's forms which include Fluid Elements.

This application is a continuation in part and sciences continuation in part of these applications:

No. 12/658,099 Feb. 10, 2010 and PCT/US210/001379 May 10, 2010 and PCT/US210/000187 Jan. 25, 2010 and PCT/US210/000188 Jan. 25, 2010 (sciences only) and No. 12/453,444 May 12, 2009 and, No. 12/382,448 Mar. 17, 2009 and No. 12/320,441 Jan. 26, 2009 (sciences only) and No. 12/320,440 Jan. 26, 2009 No. 12/153,036 May 13, 2008 and No. 11/809,132 May 31, 2007 and No. 11/807,748 May 30, 2007 and No. 11/788,172 Jun. 4, 2007 and No. 11/724,752 Mar. 15, 2007 and said No. 11/809,132 May 31, 2007 and said No. 11/807,748 May 30, 2007 and said No. 11/788,172 Jun. 4, 2007 and No. 11/504,304 Aug. 14, 2006 and No. 11/385,078 Mar. 20, 2006 and said No. 11/724,752 Mar. 15, 2007 and No. 11/418,157 May 3, 2006 and No. 11/342,006 Jan. 30, 2006 and No. 11/233,546 Sep. 23, 2005 and No. 11/212,943 Aug. 25, 2005 and No. 11/188,339 Jul. 25, 2005 and No. 11/028,982 Jan. 3, 2005 and No. 10/869,752 Jun. 16, 2004 and No. 10/840,152 May 5, 2004 and No. 10/742,485 Dec. 19, 2003 and No. 10/190,993 Jul. 8, 2002 and No. 10/156,192 May 28, 2002 and No. 10/074,966 Feb. 13, 2002 and No. 09/850,927 May 8, 2001 and No. 09/518,884 Mar. 6, 2000 and No. 09/376,957 Aug. 18, 1999 and said No. 10/869,752 Jun. 16, 2004 and said No. 10/840,152 May 5, 2004 and said No. 10/156,192 May 28, 2002 and said No. 10/074,966 Feb. 13, 2002 and said No. 09/850,927 May 8, 2001 and said No. 09/518,884 Mar. 6, 2000 and said No. 09/376,957 Aug. 18, 1999 and said No. 10/869,752 Jun. 16, 2004 and No. 10/195,668 Jul. 15, 2002 and No. 10/073,914 Feb. 14, 2002 and said No. 09/850,927 May 8, 2001 and said No. 09/518,884 Mar. 6, 2000 and said No. 09/376,957 Aug. 18, 1999 and said No. 10/742,485 Dec. 19, 2003 and said No. 10/156,192 May 28, 2002 and said No. 10/190,993 Jul. 8, 2002 and said No. 10/073,914 Feb. 14, 2002 and said No. 10/074,966 Feb. 13, 2002 and said No. 09/850,927 May 8, 2001 and said No. 09/518,884 Mar. 6, 2000 and said No. 09/376,957 Aug. 18, 1999 and said No. 09/850,927 May 8, 2001 claims benefit of No. 60/231,514 Sep. 9, 2000 and claims benefit of No. 60/226,750 Aug. 21, 2000 and claims benefit of No. 60/220,358 Jul. 24, 2000 and claims benefit of No. 60/217,308 Jul. 11, 2000 and said No. 09/518,884 Mar. 6, 2000 (contains said No. 09/376,957 Aug. 18, 1999) and claims benefit of No. 60/123,504 Mar. 9, 1999 and claims benefit of No. 60/123,207 Mar. 8, 1999 and claims benefit of No. 60/123,153 Mar. 6, 1999 and said No. 09/376,957 Aug. 18, 1999 and claims benefit of No. 60/123,504 Mar. 9, 1999 and claims benefit of No. 60/123,207 Mar. 8, 1999 and claims benefit of No. 60/123,153 Mar. 6, 1999 and said No. 09/376,957 Aug. 18, 1999 and No. 08/950,898 Oct. 15, 1997, Pat. No. 5,941,273

### FIELD OF THE INVENTION

Fluids energy highest Advanced Processors conserving embody functional Fluid Element forms.

### BACKGROUND OF THE INVENTION

Global warming, water depletions and energy crisis and sciences Principal Theories are resolved.

Inventions real novelty occupies one or more of these artificial and real domains: a) precedent; b) forms equal functions; c) functions equal forms; d) science; and e) God's forbidden mechanisms; listed proprietary bibliography disclosed, here, continued fluids science technologies conforming functions least mass perimeters mass energy highest conserving (MEHC) comprise mass energy globose and conduit (GC) processes universe forms MEHC configurations perimeter boundaries.

The United Nation's International Panel on Climate Change (IPCC) exhaustive, scientific studies reach global warming environmental consensus and cooperative governments global regulations, focusing primarily on anthropogenic global warming (AGW) and regulations on carbon dioxide emissions into the atmosphere. Such global warming regulation requires exhaustive monitoring.

Fluid Elements as global device(s) confront the natural as well as anthropogenic global warming.

No sciences engineering construction technologies come comparatively close to these inventions.

### SUMMARY OF THE INVENTION

Fluids' systems Fluid Elements, as Atomic Elements, least energy of distortion conforming least quanta masses energy quantum units paths of passage (PP) lengths least sum (PPLLS) constitutes path lengths mass energy highest conserving (MEHC) included directional and rotational tensors, with gravitational field one direction preference over the other two directions; fluids quanta, with centric quintessential core (QC) properties defines QCMEHC; in natural disposition atmospheric conditions (ND) and entirely frictionless perimeter boundaries MEHC constitutes QCNDMEHC. Said MEHC, QCMEHC, and QCNDMEHC, with advanced Processors included fluids turbulent flows, analogous to Atomic Elements, comprise Fluid Elements, Isotopes, and Ions, respectively. Uniform and nearly uniform fluids and/or elevated pressure Fluid Elements comprise QCMEHC.

An advanced Processor couples the Earth's magma and mantle magnetic field functions, and couples mantle quanta masses vital groundwater, polar caps and glaciers, less couples continental waters and oceans, partially decoupling atmosphere, and least coupling the ionosphere mass with electrons; mantle crustal mass density discontinuity boundaries restrict heat and electrical energy transfers, which decelerate the Earth's mantle, atmospheric fluids gaseous boundaries distending, and magnetic field weakening and Fluid Elements mass energy highest conserving quintessential core natural dispositions (QCNDMEHC) embody functions configured complete compliments of boundaries longevity forms, forms least energy of distortion volume changes, with stratifications gradations forbidden mechanisms forced plasma outflows; an optimally diatomic atmosphere and fluids composition MEHC genres embody God's forms constituted Fluid Elements, Isotopes, and

Ions principles, methodologies, innovations and inventions (FEIIPMII) technologies mass energy demand sustained en masse minima; forcing fluids mass conserving processes that exceed energy demands, natural and anthropogenic global warming (AGW), constitute this civilization's option; said advanced Processor functioning constituted magnetosphere enormous distortions, in volume and boundaries, constitute Fluid Elements crucially deformable boundaries that confront cosmic, especially solar, radiations and wind pressures with Black Holes suction killing energy demands.

Gravity sink generally and magnetic field crucially enforce said mass energy coupling processes, wherein the Earth's magnetic field strength constitutes integral genre of the Earth's mass energy. Aforesaid, in a very brief summary, tots up causal effects of global warming and lone solution(s). The Newton's gravity discovery, through a fallen apple from a tree, overlooks causal effects after said apple verified the coupling of the Earth's fluids in said Processor mass energy conservation. But, allowed to dry, the apple under Sun's radiation looses its fluids, water, to the atmosphere in a partial decoupling from ground masses; rising as a water vapor raised to sufficient altitudes, the water fluid portions, under excitations of the Sun radiations, can break into oxygen and hydrogen ions energy, whereupon hydrogen ions escape said gravity sink and said electromagnetic field, in decoupling processes forbidden mechanisms; plasma outflows Jean's Fountains mass and energy consist of nitrogen, oxygen, hydrogen outflows, squirting from the electromagnetic field's cusps.

Consequently, the Newton's shell theory is missing a term integral of mass energy transport from shell to its centric part, from the time of the Big Bang to present; thus at a time instance fluids mass energy in transport from said shell to the centric portion constitutes mass energy demand of centrically positioned Black Hole. Gauss elegant computations of said shell likewise missed said fluids mass energy demand term. To explain gravity as a property, at one time, Einstein came up with a Universal constant which he subsequently called his greatest blunder. Foregoing discloses mathematical science cannot predict forcing forbidden mechanisms' none zero possibility events.

Shell Theory model is more likely that of a galaxy than the Universe; taking the Sun's radiations relatively constant in the last 2000 years (within 0.1-0.2%), as mass energy radiation generalized transports, correlate the Miki Way Galaxy, galaxies in general, relatively constant polarities, with mass energy demands through millenniums generally constant but varying among galaxies. Said fluids mass with energy polarity constitutes a sink and a source for planets and stars; in forbidden mechanisms realm, said genres switch polarities: a planet becomes a source or a star constitutes a sink, with fluids mass and energy densities forbidden mechanisms dominance, forcing processes. The gravity sink force genre constitutes fluids mass and energy evolutions quest seeking a lowest potential mass energy sink, which totted up includes properties of celestial dynamics, in common causes search for the Universe mass energy balances, only achievable by forced lowest potentials of mass and energy; said celestial bodies gravitational mass and energy quests continually search for lower mass energy potential. When two bodies with celestial dynamics do not merge, portion of their dynamics and mass will change toward a more delicate balance lowered mass and energy potential sinks of the evolved two. Normally a planet as mass energy sink gradually looses a part of its mass, even if subatomic; it undergoes a forbidden mechanism polarity switch, which forces a source mass energy functions. Said polarity switch ultimately tests celestial dynamics to which bodies merge or separate more, illustrating mass energy evolutions extremely balanced Universe.

Spacecraft Cassini video shows the Saturn ice crystal rings deflecting in a response to the Saturn moons passing, wherein most likely least coupled ions leave said rings to merge with mass of the closer moon. Likewise, as the Moon passes through the Earth's magnetotail, electrically charged particles transfer to the Moon's mass; said evolution Black Holes quest for lowest potential mass energy sink mandating polarities-switch chains of forbidden mechanisms can comprise a galactic fluids largest source. Coriolis Effect discloses the Universe extreme dynamics precise laws, with water in pans and hurricanes, in the Southern, Northern Hemisphere clockwise, counterclockwise rotations, respectively; consistent with said pan and Hemisphere genre analogies, Universe space is frictionless media mass energy comprises a degree of symmetry about galactic disk planes and includes three directional sinks, Black Holes. A hurricane eye fluid low pressure is analogous to about a half portion of postulated Black Hole symmetry. In said analogy, tornadoes which occur at hurricane fringes at low pressures, with hurricane eye lower pressures, correlate with Celestial Systems on galactic outskirts; the Solar System exemplifies higher potential level of mass energy than the Milky Way Galaxy Black Hole, with the Earth's genre mass energy switching polarities. Galaxy Black Holes, said mass energy polarities largest sources with lowest potential sinks, exert influences over celestial bodies constituted said polarities interconnected nodes network, creating mass and energy dependencies, which extend to the furthest reaches of spiral or globose galaxies. Galactic mass energy said influences with accuracy, sensitivity dominance enforced by the Black Holes, preclude continuum space-time warping since higher and lower mass densities are needed on warped plane(s) continuum common faces, which the Laws of Mass and Energy Conservation prohibit, unless a warping mechanism constitutes enormous dimensional space-time continuums; whereas, the Universe constitutes conglomerates of galaxies restricted space-time continuums, to boundaries of each galaxy, where discontinuities occur constituted by magnetic and gravitational fields' confrontation among galaxies, Black Holes, mass energy said densities, and said polarities confrontations or switching; the Earth's magnetosphere, gravitational field perimeter boundaries, exhibits and effects magnetic lines' disconnects, with forbidden mechanisms said discontinuities. Disk planes of galaxies do not align. It is more not than likely to expect warping and equilibrium at Galaxies extreme boundaries, which allow a Black Hole said mass and energy highly sensitive boundaries and influences inside its galaxy. Celestial bodies' polarities switch includes extreme universal dynamics globose spiral forms, here and references referred to as circumferential strain with stratifications gradations Universe processes MEHC evolution forced lowest potential level.

Einstein did not account for said forbidden mechanism hydrogen escape from the Earth's mass or similar Nitrogen and Oxygen escapes, said plasma fountains, Jean's fountains; thus he missed on a Black Hole function, even as he anticipated an existence of one; entirely unaware of said Black

Holes huge mass energy demand, Einstein missed the Theory of Uniformity enforced throughout the Universe processes, functions that operate now and operated in the past, to unify mass energy dynamics, thermodynamics, and atomic energy in magnetic and gravitational fields, according to the Laws of Mass and Energy Conservation. Fluid Elements comprise the Universe mass energy forms building blocks that subdivide into Galactic bodies, with planets evolving crustal surfaces;

within the Universe, fluids' Fluid Elements and said Isotopes plasma, if necessary forced through forbidden mechanisms, unify in seeking celestial bodies a lowest mass energy potential magnetic and gravitational sink, said fluids delineated fields densities, continually evolving lower potential mass energy perimeter boundaries, enforcing celestial bodies functions advanced Fluid Elements, advanced Processors. Stratifications, gradations most natural processes convert planetary atomic elements, at least in part into fluids which said forbidden mechanisms convert into plasma, which the Earth's said plasma fountains discharge into space seeking mass energy lower level potential. AGW processes essentially constitute stratifications, gradations main function essential parts that deplete the Earth's fluids potential mass energy levels. Supra constitutes utmost and enormously significant disclosure that reveal the Universe as mass energy enormous Processor Fluid Element with respective advanced Processor components, configured Fluid Elements making up Galaxies, celestial bodies and Black Holes least potential energy levels and fluids energy demand transient continuum, in said Processors MEHC stratifications with gradations function processes continual search for lower potential levels; said energy demand continuum steady flow known composition and said Processors noted functions and the Theory of Uniformity with depletion of Nitrogen and Oxygen, Hydrogen, water molecular versions imperil this civilization. Said advanced Processors plasma and lightest atomic elements mass densities in space rank highest in importance, as water conserving, global energy demand, AGW and natural global warming unite in one eminent issue.

The Earth orbiting the Sun orbited the Milky Way galaxy, Black Hole about 20 times. Almost a “dead” certainty is that said orbiting includes near Black Hole passes. Said Cassini observations constitute irrevocable evidences that during such a near Black Hole throe, the Earth and all of the planets in the Solar System lost all of their fluids, including wipeout of all magnetic fields. Only masses of fluids ice highly coupled to planets crust were not pulled with said Black Hole suction, out of respective magnetic fields energy domain; thus, the Earth experienced enormously long 20 glaciation periods forced magnetic field wipeouts with at least three changes in dispositions; with potential glacial periods of 120-140 ka, climate changes occurred over 1500 times, which reveals Solar System planets' present status causal effects and AGW CO2 emissions control relevancies.

Black Holes' mass energy streaming demands, MEHC, and magnetic and gravitational fields rule the Universe with densest mass energy densities dominating at confronting perimeter boundaries, and thus gravity mass energy sinks, minima maxima—conforming least mass MEHC—functions forcing forms equal functions—functions equal forms, evolving globose spherical celestial bodies. Said fountains light fluids plasma outflows, through magnetic field cusps, pay with highly valued commodities—nitrogen and water based ions that constitute outflows plasma; strongest magnetic field, and gravity sink, least volume ionosphere light fluids densest boundaries are a forced must;

If ever there was a specific time in evolution of this civilization, it is now. This civilization must drastically change habits and en masse implement revealed sciences said FEIIPMII technologies.

Said advanced Processor mass energy comprising magnetic field shielded quanta mass functions include: the advanced Processor's Fluid Elements, Isotopes, and Ions and living organisms fluids mass densities, magnetic field lines magnetic poles two cusps inverted from inside its ionosphere and electrically charged stratosphere and upper atmosphere; the two cusps embody generic forms of electromagnetic field lines of a GC globose inverse offset centric Set, with an open mouth two Inlets interchangeable with an orifice two outlets or interchangeable an orifice outlet and an open mouth Inlet, as interchangeable parts of said advanced Processor deformed perimeter boundaries.

Civilization's only recourse comprises en masses implemented Fluid Elements, Isotopes and Ions principles, methodologies and innovations, listed priority and reference applications exemplified.

Fluid Elements, Isotopes, Ions principles methodology, inventions, innovations (FEIIPMII) force optimally contained energy inside fluids' functions, minimal energy release into fluids perimeter, thus comprising perimeter boundaries optimal longevities entirely coupled fluids mass energy, or optimal duration coupled to the Earth's crust, which emits least mass energy into the atmosphere.

Disclosed Universe Galaxies celestial bodies, Black Holes and Fluid Elements, Isotopes and Ions mass energy functions, making the Shell Theory whole, resolve the Theory of Uniformity issues. Human lack of vision overcome by the Shell Theory made whole, thus the Theory of Uniformity solved and validated, reveals the Earth advanced Fluid Element functions magnetosphere volume relative variations forced by said cosmic radiations and wind pressures and said Black Holes sink streaming mass energy demands depend almost entirely on strength of the Earth's magnetic field. Priority Data applications, specifically PCT/US210/001379 details that extensively, documenting said Fluid Elements, Isotopes and Ions, Sets advanced Processors inorganic and organic analogy, comparative human and Earth concurring core processes; said FEIIPMII coincident relationships QCMEHC or QCNDMEHC FEIIPMII force fluids energy forms Set MEHC mechanics of forms. Said FEIIPMII analogies disclosed Universe, Galaxies celestial bodies and Black Hole functions, by resolving the Shell Theory and the Theory of Uniformity, cracks the Theory of Everything; in FEIIPMII solved said Theories discloses the Theory of Evolution disconnects with missed fluids' mass energy effects on evolution. No record of advancing civilization surviving a glacial period, a human civilization migrating in pursuit of water and/or a magnetic field repositioned adversely.

The Priority data references and this application disclose said FEIIPMII, exemplified by celestial bodies showing—forms equal functions or vice versa. Light fluids GC Universe natural versions of MEHC embody fluids continuum advanced Processors. Said advanced Processors constituted magnetic field outer magnetic lines that deflect light fluids streaming flows, from the nearest Star toward Black Hole; the Universe searches for fluids energy optimally lowest potential level place life and death values on integrity of the magnetosphere crucial boundaries. Stars as sources, with Black Holes as sinks, place planets in forbidden mechanisms domain, wherein a planet can act as a source or as a sink or neither, depending on strength of its magnetic field lines and energy of its light fluids gravity sink; the Earth's mantle cooling with ubiquitous light fluids stratifications and gradations natural air warming and AGW distending of magnetosphere assist a Black Hole order.

In the Theory of Uniformity, said amended Shell Theory applies to galaxies; a globose, a rotating spiral galaxy subdivides into commonality of infinite number of respective globose, spiral shells. Each shell contributes a share of energy demand continuum, from an outer into an adjacent shell. Essentially, a steady flow mass energy continuum transport extends progressively, constituting a respective Black Hole control over said continuum, enforcing the Galaxy mass energy functions. A Black Hole uniquely grows mass energy, keeps and lowers lowest potential mass energy level, similar to tropical depression low barometric pressures forcing hurricane eye and strength levels, wherein Black Holes energy demands for frictionless light fluids huge energy are uncontrollable.

The Universe quenchless insatiable mass energy imbalances enormous persistence to balance the Universe forces celestial bodies to subdivide themselves into Fluid Elements with infinite variety boundaries, perimeters. Black Hole suction forces successive perimeter boundaries to collect light element ions and isotopes, while denying transports of such energy light fluids to neighbors; plasma fountains reveal light fluids mass energy universe functions and natural air warming said effects, the missed term in Newton's Shell Theory, as root and real core issues, with AGW a symptomatic and transient participant. And, in a nutshell that is all there is to it.

Stars provide most of a continuum mass energy that eventually ends in Black Holes. The planets supply a part of that continuum; the Earth masses are essentially a light fluids source, because of: the huge sources of water subject to evaporation processes, parts of said stratifications gradations forcing, atmosphere's volume, AGW ever since industrial revolution, dependence in a major way on the solar radiations activity, Earth's magnetic field retained ionosphere's large projection and battered by continuum plasma stream flows, and steadily evaporating fluids of gravity force sink. Earth advanced Processor functions, comprising Fluid Elements, Isotopes, and Ions functions, go into forbidden mechanisms, leading to said plasma fountain periodic discharges with particularly significant partial atmospheric blow-offs, conforming to Milankovich's cycles significant climate changes about every 120 000 years, 120 (ka), with four equal duration periods; diatomic air mass molecules contain interstitial voids similar to round gap graded sand particles, thus highly porous to good portions of solar and interstellar radiations and the Earth irradiations that pass into space; by additions of triatomic water vapors, which permeate air masses similar to water saturating the soil, and greenhouse gases make air masses less permeable to said radiations; the atmosphere air temperature rises enforce more evaporation, said partial water decoupling from the Earth's mass, which by buoyancy rise into upper atmosphere. That assimilates more radiations and perpetuates cycles with increasing air temperatures; especially, in the upper atmosphere, the cosmic and solar ultraviolet radiation impact that split molecular air water vapors into ions force the atmosphere to experience energy of distortions and energy of volumes change, in global warming phenomenon, temperature rises with ionosphere continual optimum volume caused increased evaporation rates; the described forbidden mechanisms embody a prelude to said plasma fountains plasma outflows that locally decrease air mass pressures and temperatures, thus forcing asymmetric precipitations.

An advanced Processor boundaries magnetic field functions shielded fluids volume distortions and mass energy transfers, forced natural with unnatural air warming phenomena, with triatomic, higher multi-atomic gas molecules, greenhouse gases and water vapors forced partial decoupling from a cooling mantle into a surrounding atmosphere, fill diatomic nitrogen and oxygen rounded molecules interstitial voids; a saturated atmosphere low porosities retain radiation and irradiation heat energy; raised atmospheric temperatures increase water evaporation rates; in perpetual cycle causal effects, decoupled masses buoyancy forces water vapors mass into higher altitudes, below an ozone layer, created under solar radiations, from water vapor molecules broken apart into ions of hydrogen and oxygen, which along with nitrogen ions in forbidden mechanisms escape from a magnetic field light fluids gravity sink; in decoupling processes, energy of distortion and volume changes, including molecules breakup, distend fluids mass volume of a magnetosphere boundary and force stratifications and gradations forbidden mechanisms plasma fountains energy outflows.

Ocean tides attest that celestial bodies deform perimeter boundaries of the Earth's fluids, for said instance, essentially by the Moon's body mass; said magnetosphere instantaneously and severely deforms under solar radiations, showering the Moon with subatomic particles as the Moon passes through its magnetotail; said atmosphere's globose forms likewise deform forced by cosmic with solar pressures and radiations and close-by celestial bodies gravity sink fields configuration; and,

continuum dynamics force gravitational field and atmosphere's essentially stable, energy benign, offset centric Globose Inverse Set, in blow offs migrating into an energetic Globose Sidelong Set globose forms changes, with the Black Hole's stratifications, gradations fluid functions enforcing lowest mass energy potential levels and magnetopause's enormous distortion enforced by suction at magnetic field cusp shoulder, and thus partial or significant atmospheric mass energy blow off.

The Earth's magnetic field parts or entire magnetic field may blow off, in extreme reconstruction taking a lowest energy disposition; hematite bedrock formations reveal—this occurred in the past.

Evaporation processes distended magnetosphere volume projected into primarily solar radiations, said energy demand streaming continuum at optimal magnetic field lines extension and distances from center of an Earth's gravity field sink with the Milky Way Galaxy's Black Hole potential at lowest level, force said Earth's advanced Processor Fluid Element Globose forms migration with said blow-off; the magnetic field subsequent reconstructions allow enormous expansion of an air volume in cooling effect that precipitates most of vapors, restarting a highly porous and diatomic atmosphere, and thus, trigger a glacial period; with sufficient water resources, said 140 ka cycles continue. Said evaporations, electrolyses, atmosphere dynamics and suction processes constitute unfriendly, forbidden, mechanisms that continually harvest the Earth's light, least coupled fluids; water resources depletion or an electromagnetic field weakening leads into a sterile and frozen or conversely, an overheated planet. A planet needs water vapors mass to moderate its atmospheric temperatures; once a Black Hole partially couples most of its Galaxy light fluids atomic elements with stratification gradation processes, it essentially captures its entire galactic mass energy. The Earth's gravity sink force field is mainly passive and too week to counter streaming said plasmas continuum constituted of light atomic elements, mostly ionized plasma with no sheer strength, no cohesion, same electrical charges stratification gradation processes dispersed rounded frictionless particles that seek mass energy dynamics lowest level potentials. Suspended in said mass energy demand continuum dynamics, electrical charges dispersed particles, must deform magnetosphere and if necessary disconnect outer magnetic lines; otherwise, the magnetosphere's volume dams a streaming energy demand continuum, with suction on the lee side, that may disconnect a number of magnetic lines necessary, to enforce streaming continuum or, if necessary, partially or entirely drain or blow-off the atmosphere. Proximity of said energy demand continuum dynamics govern over said gravity sink strength, at these altitudes. Magnetic field lines optimal strength is a must.

A gravity sink and an electromagnet field mass energy retained fluids can not decouple from a mass energy enormous demand of the Universe, Milky Way Galaxy celestial bodies gravity sinks mass energy fields, and Black Hole suctions; said electromagnetic field lines fluid masses cannot avoid constellatory radiations and wind pressure effects; a planet's surfaces with solidified fluids as a phonographic record of magma displacements, and polar ice caps, glaciers, and groundwater partial decoupling changes with solidified mantle gradation and stratification processes recording erosional features, nearly eternal geologic history, that supplement a globose conduit (GC) offset inverse magnetosphere boundaries current period forms Set, mass energy effects constitute these: a) splitting triatomic molecules, air temperature rises with Jean's fountain plasma losses to space;

b) a planet constituting said advanced Processor GC Fluid Elements electromagnetic field, with a magnetosphere constituting ionosphere distending boundaries enforced fluid fountains mass with energy outflows; c) the Processor's mantle cooling, crusting forced light fluids energy processes, forcing seismic events energy of volume changes and distortions, with magnetic field weakening.

Crucial aspects that disciplined, conscientious civilization can control are the atmosphere's mass energy volume and temperatures with ubiquitous functioning Fluid Elements, Isotopes, and, Ions that implement said advanced Processors a mass energy and temperature processes management. Listed reference documents, especially Ser. No. 12/153,036, include more details on climate controls.

In rudimentary Fluid Elements, fluids' mass composition constitutes function of variables, whose composition quantum mass units multiple constitute Fluid Element(s) quanta forcing function(s); given mass energy compositions MEHC, Fluid Elements quanta then comprises quanta functions fluids conforming least mass volume contained highest energy. Herein, listed references priority documents and, herein, said MEHC—synonymous to computed—constitutes quantum mass units paths of passage (PP) lengths least sum (PPLLS) and quantum upright directions motion with the gravitational component multiple. Unmanageable maxima and minima mathematical complexity reduces to algorithm models computed said least fluids quanta MEHC that constitutes least fluids mass energy to sustain quanta perimeter boundaries, in perimeter boundaries optimal longevities.

An advanced Processor correlates with said rudimentary Fluid Elements. A planet gravity sink is radially omnidirectional from its center and compares to rudimentary Fluid Elements limited to a local up or down direction; the Earth said fluids composition comprise quanta and quantum mass units extreme genres with diversities. But, the Laws of Mass and Energy Conservation functions for MEHC fluids perimeter boundaries and thus energy fields transforming directionalities holds.

A fluids composition functions conforming globose least quanta compact composite with free-surfaces at highest elevation, said quanta a globose conduit perimeter boundaries a Set and forms a least length least rotations and a least volume surfaces constitute said quanta fluids least energy fluids outflow, comprising an advanced Processor least coupled light fluids optimal densities that optimally retain said Set free surfaces perimeter boundaries of its fluids energy GC forms—Fluid Elements; said quanta conforming least mass boundaries evolving fluids energy constitutes Fluid Elements, Isotopes, and Ions, fluids advanced Processor generic Sets, a radially serial boundaries energy, comprising a uniquely superimposed a magnetic field and a gravity sink lowest potential.

Said Rudimental Fluid Elements globose conduit GC Sets, mass energy fluid functions appear in two direction gravitational field, only. However, Fluid Elements configured into a common field comprise near and distant units with fluid horizontal free surface noticeable free surfaces change.

Evolving Universe, Galaxies and Black Holes streaming radiations and wind pressures relentless energy demand, especially forced by the Milky Way Galaxy, depletes the Earth's masses energy;

the Earth crustal boundary itself largely retains electrical and thermal energy internal conduction, which lessens gaseous fluids distended boundaries and Earth's cooling weakened magnetic field.

Said Advanced Processor's Fluid Elements reveal that planets functioning constitutes a low level energy fluids sink potential that combines with a weak electromagnetic field, constituting a weak energy demand presence that is forced to respond to Black Holes enormously stronger fluids sink potentials. Said plasmas streaming demand, as source of energy is a captive of said Black Holes' sinks; said Black Holes gravitational mass energy sinks also capture commanding Stars presence, in respective supra streaming energy demand fields despite enormous energy outflows from Stars thermonuclear fusion processes in their cores; galaxies with respective Black Holes constitute the Universe function processes, constant highly delicate balance continual search for compaction of entire mass energy into the lowest potential energy sink of one enormous body, by said mass and energy forcing demand; mass energy combats extend through endless processes of stratifications, gradations, unifications and compactions. The Universe functions force Black Holes unifications to one space time location, with dynamics that preclude a break up; one Universe one Black Hole body warped space time is possible. In galaxies subdividing Universe, said energy demand sinks with warped space time and no conceived forbidden mechanism contradicts the Mass and Energy Conservation Laws. For this civilization, with those to come, warped space time final scenario is unacceptable final outcome; forced lowest potential mass energy demands that preclude warping within a galaxy likewise preclude warping of continuity within galactic perimeters at boundaries. Light elements air molecules and especially plasma, in apparent reason, constitute invisible mass and energy to human vision; with gradations stratifications, said processes said plasma subject to Black Hole forces stacked mass energy enormous compaction comprises ionic perimeters human vision least detectable wherein light rays passing distinct density layers appearing kinked or bent.

PCT/US2010/000188 application, Sustainable Processes Super Green Nuclear Super Plant (SP), reveals construction of FEIIPMII symmetrically configured equipment inside compartmentalized buildings, including subgrade construction equipment multiple perimeter boundaries in electrical power generations least volume change and energy of distortion, wherein the SP all mass energy, including electrical that leaves the site, constituting fluid mass in the Earth's crust coupled phase.

All prior art construction technologies generating energy are defunct, useless and detrimental in confronting suction by said Black Hole(s), as they release light fluids mass and energy into the atmosphere, distending the Earth's fluids successive and crucial perimeter boundaries that impact deleteriously air temperatures. Said Sustainable Processes Super Green Nuclear Plant constitutes the sole and only exception, wherein said Fluid Elements MEHC version(s), least energy of distortion as perimeter boundaries technology, optimally contain fluids and energy.

Said advanced Processor boundaries comprising magnetic field shielded quanta mass functions, said FEIIPMII and universal GC Sets and SP combat, oppose scramble, stratifications gradations forbidden mechanisms processes; consequently the Earth's strongest magnetic field is a must do; said GC Sets with SP buried thermal aqueducts, strategic heat energy transfers, technologies with said FEIIMII, constitute only means for a strong magnetic field and this civilization only options.

The priority applications, PCT/US210/001379 and Ser. No. 12/153,036 with Ser. No. 12/453,444 compile details not repeated herein, especially the details of an unfriendly science forbidden mechanisms, Milankovich' cycles, said stratifications gradations status processes of near planets, Solar System interplanetary status, including function of rudimentary Fluid Elements and advanced Processors. Said application Ser. No. 12/153,036 detailing of geological formations astronomical revelations find Earth's stratifications and gradations electromagnetic field taken disconnects, global air warming forcing, and the Earth's mantle cooling, geologic histories depleted ice, water, and vapors energy budgets, which threaten a waterless and a frozen planet, forced hydrodynamics, thermodynamics.

From the time of the Shell Theory formulation, going forward, mankind global presumed that there is this handles on the civilization future existence. Said profound euphemism continues today and is science reality entirely devoid. The Shell Theory missing term revealed, as light element(s) ions and isotopes mass energy that escapes through said Advanced Fluid Elements perimeter boundaries, balances the Universe functions omnipresent mass energy unbalance in perimeter boundaries. Said valid sciences correction, said resolved Theories, and disclosures change everything. Stated sciences, methodologies, technologies, innovations and inventions change the prior art highly obsolete or defunct fluids energy technologies and methodologies. Unless revolutionary changes are swift, comprehensive, and global, there is no doubt that this imperiled civilization suffering grievously through millennia may eventually become extinct.

The innovations and inventions, herein, oppose and reverse the Earth fluids energy stratifications gradations, along with said Earth's cooling, AGW, and natural global air warming, processes that weaken the Earth's magnetic field strength and fluids energy sink and distends the magnetic field lines and/or condones light fluids mass energy decoupling processes that imperil this civilization.

Fluids' conservations MEHC constituted fluid functions with boundaries optimal longevity force fluids least mass functions least energy of distortion and volume change; causal effects evidence, frozen status of a planet more distant from the Sun than the Earth, and additionally in FEIIPMII a magnetic field functions relevance, reveal water mass, AGW, and natural global warming energy crises; said FEIIPMII energy of distortion longevities least rate of failures comprise water vapors least decoupling, as the SP aqueducts heat energy transfers remove crucial triatomic water vapors from the atmosphere, constituting electrical energy generation minimal AGW; all that constitutes optimally controlled diatomic atmosphere forced climate control; said aqueducts added irrigation functions transfer atmospheric water vapors into groundwater mass coupled to the mantle's crust; water coupling mass energy transfers, enforcing continental crust expansion, hinder volcanic and tectonic events and cooling mantle coupled to least coupled mass energy abrupt volume changes.

Said SP fluids implement water vapors alternate paths into the continental crusts groundwater, as the truly valid device that resolves energy crises, natural and AGW, and water conserving issues.

Accordingly said advanced Processor comprising magnetic field shielded quanta mass functions, by Fluid Elements sustainable processes, with super green nuclear super plant slurry walls sealed buried thermal aqueducts, irrigation distended groundwater boundaries, and precipitation warmer and groundwater cooler energy coupling reverse said distending gaseous boundaries fluid energy decoupling, by enforcing coupled and partly decoupled mass energy paths into the Earth's crustal boundary; the Earth crustal boundary retains most of internal electrical and heat energy transfers, lessening gaseous fluids boundary distending and said Earth's cooling magnetic field weakening; said FEIIPMII civilization's lone recourse comprises Fluid Elements minimal fluids mass energy demand science technologies sustainable solutions, global warming and energy crisis combat and en masse water conserving, that together must arrest natural with anthropogenic global warming.

Milankovich cycles reveal that every 100-140 ka triggers a climate change, following a partial or a complete blow-off of the Earth's magnetic field, with parts or an entire atmosphere, attesting to the importance of fluids, especially water phases status stated coupling to the Earth's mass; listed reference, GC Boundaries, U.S. Ser. No. (Ser. No.) 12/153,036, compiles undisputed geological histories of hematite bedrock layers recorded magnetic field shifts, Earth's crust erosion features, including retreating glaciers history of ground surface deposits, and astronomical observations of adjacent planets overwhelming evidence - the Earth Fluid Element advanced Processor sustains a delicate balance presence in the galaxy by said fountains periodic outflows plasma mass venting. After a blow-off, magnetic field lines reconnect resurrecting the magnetic field with atmospheric volume sudden expansions, which cool the atmosphere, force enormous precipitations, and force triatomic water molecules out of the atmosphere making it mostly diatomic highly porous fluids; said process drops the atmospheric air temperatures and allows higher portion of Sun's radiation and the Earth irradiation to pass-through, forcing a glacial period. Subsequent atmospheric mass energy water vapor regenerations with volume increase restart said process and plasma fountains outflow; said properties and/or suctions, at magnetosphere cusps that force a blow-off, are highly dependent on the magnetic field strength, wherein said gravity sink comprises a secondary effect.

The application Ser. No. 12/153,036 describes air compactions processes, by substitution of diatomic molecules with triatomic water vapors, diminishing voids in interstitial spaces; in less permeable fluids rising temperatures and fluids evaporation higher rates, water vapors buoyancy pushes that fluid to higher altitudes increasing a rate of water vapor molecular breakup into ions; said cosmic radiations and Black Hole suction pull hydrogen ions through magnetosphere boundaries or force said nitrogen, hydrogen, and oxygen fountains. Greenhouse gas emission cuts cannot address the Universe advanced Processors light atomic elements energy demands, by evaporation, buoyancy, ionization, combustion, erosion, corrosion, friction and such, stratifications, gradations processes fluid boundaries destruction, as Black Holes' outreach that controls galaxy mass energy domains.

Triatomic elements and multi-atomic molecular structures greater diversities forming a larger mass in the atmosphere during interglacial periods are not an unnatural phenomenon. Causal effects of AGW constitute transient contributions to the climate change(s), when compared to duration of the Earth's longevity that includes glacial periods. Misled by an incomplete Shell Theory, said missing term; while missing said Fluid Elements science that resolves Theory of Uniformity and Theory of Everything, scientific communities under United Nations covenant conducted exhaustive global studies. For lack of firm solutions to climate change, the studies presented lengthy evidence that correlates average temperature rise and carbon dioxide in the atmosphere. Said correlation exists, but said Black Hole(s) suctions of said light isotopes, and ions mass by gradations and stratifications said processes constitute true causal effects, which during interglacial periods raise temperature and CO₂ levels in the Earth's atmosphere. Made up of light elements heavier molecular structures that do not break down readily into ions, the atmosphere of the Earth's neighbors closer to the Sun, stripped of light element fluids by said processes, consist entirely of heavier carbon dioxide and methane fluids at high temperatures. Mars atmosphere small mass, stripped of said light element fluids, consists of carbon dioxide ice that sublimes into vapor under sufficient radiations from the Sun. All of the above, which Summary of the Invention and the priority and referenced documents details point out, leaves no doubt—extensive details of root causes and the inventions said solutions hold true indeed.

Carbon dioxide heavier molecular weight, with resistance to separate into ions, must return to Earth, which forces permanently that CO2 mass out of the atmosphere, unless new CO2 mass replaces it; thus, the Earth integrity systems restore crucial diatomic air porosities and energy balances normal perimeter boundaries; said processes decoupling increases water vapor mass and forces precipitations accelerated recycling rates, accelerating an ionized mass decoupling from the Earth's mass; this process can accelerate out of control to trigger a blow-off and/or a collapse of the ionosphere. Captured in stratifications and gradations processes, a light fluids energy only release constitutes a decoupling from the Earth's mass gravity sink and magnetic fields, in plasma fountains outflow that risks status of magnetosphere Globose Inverse forms.

With supra disclosures, most risky electrical power generation is geothermal, as it weakens supra crucial magnetic field functional strength, forces energy of distortion and volume change deep in the Earth's crust and potential volcanic action and/or tectonic movement fluids enormous energy and mass release into the atmosphere, breaching crustal surficial mass energy natural restrictions of said decoupling processes; less risky also detrimental are wind power and fossil fuel electrical energy generation. UN ICCP addresses fossil fuels emission issues; wind power electric turbines mix diatomic and triatomic molecules in optimal water vapor content most uniform compositions reducing chance of precipitation that wrings out triatomic molecules, including greenhouse gases in the atmosphere; such least permeable compositions most trap Son radiations including Earth's irradiations; by buoyancy water vapors rise; in forbidden mechanisms their molecules split which forces atmosphere and ionosphere mass volume increases. Wind turbines slowed air circulations may not significantly reduce surface water evaporation, with further increases in air temperatures because of said air lower permeability forcing higher temperatures; a diatomic, triatomic air mass better uniformities compaction diminishes precipitation chances; water vapors larger mass raised to higher elevations, upon solar radiations impact includes portions of split ions that float into the ionosphere. Thus, not precipitated the Earth water vapors, forced plasma fountains, squirt ions to space; thus ballooned ionosphere diminishes the Earth's water supply, whereas greenhouse gases settle out by weight or precipitation; water vapors as most potent of greenhouse gases make wind energy riskier of the two, as it also disorients the Earth triatomic fluids naturally evolved control.

Wind turbines ubiquity action dams up air circulation, while turbine blades compact diatomic molecules with other molecular structures, which reduces air mass porosity and permeability, that traps more heat energy in the atmosphere, which forces water vapors to rise to yet higher elevations, carrying along heavier molecular structures, such as CO2. Raised air temperature creates even more water vapor, which further heats air masses. All of that delays water vapor condensations and precipitation. And, when precipitation does occur, it comes down in huge quantities, which as gushers rush through said rivers system flood plans into tropical belt and warmest climate. All of that optimizes water vapor generation, its quantity in the atmosphere and its duration in the atmosphere, wherein under said radiation(s) corresponding percentages of vapor decoupling mass transfers from the atmosphere, constituting a distended ionosphere.

In brief summary, wind power energy generation distends atmosphere and ionosphere crucial outer perimeter boundaries, which lowers continental groundwater levels; said processes pass mass energy to Black Holes, by said gradations and stratifications fluid decoupling processes.

In addition to wind power energy generation said processes and combustions of various fossil fuels that distend the atmosphere and ionosphere volumes outermost perimeter boundaries, in insatiable energy thirst, special conditions globally force two more whammies against crucial outermost perimeter boundaries—geothermal and solar energy production. These two energy conversion technologies respectively bar solar and sap thermal energy from the Earth's crust. Said two technologies rob energy from the Earth's magnetic field lines and its outer and most crucial boundary—the magnetosphere, which increases likelihood of said blow-off processes.

Solar energy electrical generation accelerates the Earth cooling and magnetic field deteriorations. Both, wind and solar energy are detrimental and irreversible and may enhance the Earth wobbles.

The Priority data presented sciences, especially in said (Ser. No.) 12/153,036, describe and detail said stratifications and gradations Milankovich cycles, revealing forced processes a glaciation periods repeat every 100 to 140 ka, that were preceded by an atmospheric blow-off caused by the Earth's weakened said mass energy natural sink and magnetic field strengths magnetosphere boundaries. A blow-off magnet field wipeout certainly occurred 20 times; other than for a potential exception of the Kansan glaciation period, the Earth' mass from its origin and periods when covered by ice, responds consistently, not as a light fluids mass energy sink but as a source, enforcing gradations stratifications and forcing continual partial light fluids decoupling processes and climate changes that further weaken strengths of said sink and magnetic field boundaries. In fact, such is the case with the four planets closest to the Sun; it is remarkable that of said four only the Earth embodies sufficient light fluids mass, comprising sufficient molecular water with air masses that respond to natural mantle cooling and global air warming, and most recent AGW, in its crucial opposition to cosmic radiations and wind pressures and the Black Hole suction which threaten this civilization.

Most significantly at the time of polar caps melting, the continental crusts groundwater levels are dropping thus drying up the land masses; the continents continue loosing fresh water, from times when the Earth was entirely ice covered and most likely from the time of the Solar system origin, estimated about 5 billion years ago. Utmost duration of AGW CO2 emissions is about 500 years and is miniscule when compared to 5 billion years and entire light fluids energy masses the Earth lost since its origin. The Earth lost significant amounts of light fluids prior to each glacial period and at each magnetic field shift; the IPCC scientific community CO2 emissions focus is incorrect to an extent that climate change root causes reside in the continental groundwater dropping levels with causal effects of light fluids plasma fountains decoupling outflows from the Earth's masses.

The Earth's magnetosphere advanced Processor perimeter boundaries embody a Globose Inverse Set that highly deforms under forcing Solar and cosmic radiations and wind pressures, which in a fluids mass full blow-off must transform to a most dynamic Sidelong Set. Said thermodynamics AGW and natural global warming temperatures force magnetosphere electromagnetics distended said globose inverse boundaries that go into forbidden mechanisms said plasma Jean's fountains.

This civilization should urgently implement stated FEIIPMII, henceforth also referred to as Fluid Elements with fluids MEHC versions. To date, no prior art device meets Fluid Elements' genres. The prior art devices lack MEHC forces boundaries failure with released additional fluids energy cumulative amounts into the atmosphere that in causal effects reciprocity lower said groundwater levels. In the quick, said SP ubiquitous construction reverses said decoupling processes, wherein said FEPMII devices rudimentary, complex means contain, reverse said decoupling, respectively.

Black Hole suction constitutes energy usage and, in excess of usage, energy demanded, unless its function is stagnating or diminishing. No crucial evidence exists as to which actually is the case.

Thus, a much more perilous force is present, with the AGW as a harbinger of Black Hole effects. The entire prior art fluid systems include wasteful and detrimental energy boundaries, structures and forms, that shorten system longevities or even worse—continually emit potent fluids energy.

Herein construction technologies optimal longevities preclude frequent crucial AGW activities to decommission or replace a device, including associated fluids energy that is utilized and emitted.

These applications emphasize not only forms but also optimal forms equal functions or functions equal forms energy utilization constituted GC forms longevity, fluids composition, energy usage, energy demand, and energy of distortion, in opposing AGW, water depletion, and lack of energy; it is a myth to assume that said acceptance of the prior art can likewise value functions and forms of specified crucial genres from a structure appearance alone; functional descriptions are needed.

Real issues at hand find that the licensed prior art fluid inventions are lacking possessions of four most significant genres of a device: fluids mass energy composition, fluids mass required energy and fluid dynamics and a device longevity, which yield insights—how we got here as civilization, in inventions disclosures and in resolving energy, water conserving and natural and AGW issues.

Said MEHC devices ubiquitously, optimally combat energy, water conserving, natural and AGW issues, by optimal means right-at sources of causal effects, common and ubiquitous fluid devices.

A fluids systems Fluid Elements least energy of distortion, with analogy to the Atomic Elements, in quanta conforming least mass energy, quantum units constitute a paths of passage (PP) lengths least sum (PPLLS) comprising mass energy highest conserving (MEHC) path lengths directional and rotational tensors, gravitational field one directional preference over the other two directions; said quanta MEHC quintessential (QC) core (QCMEHC), under atmospheric pressures in natural disposition (ND), and nearly frictionless MEHC perimeter boundaries comprise a QCNDMEHC.

Fluid Elements forms, structures, and perimeters boundaries highly correlate to mass energy, and while known for atoms, that is not the case with the prior art fluids energy devices. A perimeters correlation must embody the three entities: forms, mass and energy, as it must constitute no more and no less than least mass energy, in forms equal functions, which are what the atoms comprise.

In achieving a Fluid Elements Set, fluids mass less than a conforming least mass energy falls into forbidden mechanisms category, structure longevities of a relatively short period; said fluid mass systems and genomes function perimeter boundary must achieve a conforming least mass energy said PPLLS Set(s) and forms, up to nearly infinitesimal accuracies, wherein the gravity direction components comprise gravity acceleration multiple; said technology embodied atomic and fluids correlation appears in space and science globose forms detail, completely missing in the prior art.

Fluids quanta of quantum units MEHC, QCMEHC or QCNDMEHC directional change concedes portions of energy, which summed over entire quanta comprises stresses and energy of distortion in perimeter boundaries. Flows energy surfaces disposition (FESD) forms optimize a fluid flows energy usage, by minimizing energy of distortion causal effect relationships of a flow directional change. Said FESD forms optimize a flow MEHC and may constitute a combination of surfaces, whose means, forms equal functions, optimize said MEHC versions, wherein fluid embodiments with specific globose forms are susceptible to numerous FESD forms; said FESD forms embody these structures and these two or more effects:

A shortened a PPLD band length—a Crescent, an Annular Valley, pitched downward basin lowest surface PPLD FESD forms ending in an essentially upright a DCSS;

A minimized conforming least quanta, minimized said quantum PPLLS—all FESD forms;

Fluids quanta conforming least mass minimized rotations—all FESD forms, especially versions of a Ridge, a Fin, a Trough, a Bridging Wall, a Nozzle, and a Partition FESD forms;

Optimally restricted and lowered a fluids quanta conforming least mass or a hydrostatic pressure—version of a Partition, a Window, a Three Dimensional Window, a Circumferential Window, a Circumferential Ridge, an oversized outlet, especially versions of Sub-outlets, and a fluids manager, and fluids manager around fluids manager three dimensional forms, as FESD forms;

A minimized fluids quanta, a conforming least mass—all FESD forms, version of a Bridging Wall, a globose End 2, a globose inverse First End, a Conical Form, a PPLD basin lowest surface form, and a fluid manager FESD forms;

An optimized complete complement, optimal configuration of forms—all FESD forms, especially a version of a Dimension 44, 44′ configuration, a manager of fluids FESD forms;

A maintenance of FESD surfaces, a rinsing, a flushing, or a coating—a version of Flush Apparatus parts and forms;

Fluids quanta dynamics subdued rotations and oscillations—DCSS Sub-outlets, GC modulating cross-sections, ND and large free surfaces and modulating fluid velocities FESD forms manager;

A conforming fluids least rotation, a conforming quanta mass, MEHC, a PPLLS, and Flush

Apparatus assemblies, in part these drawings, and these FESD forms described and illustrated:

A three-dimensional (TD), a circumferential, an axial or a transverse a Trough, a Ridge, an Inlet upright a Ridge a Trough, a Trough in a Trough, a Ridge, a Partition with/without a Window(s);

a Ridge, a Trough, a Trough in a Trough, a Partition with/without a Window(s), a Troughs-Ridge, a Troughs-Ridge-Partition and a Window(s), as FESD forms;

A Circumferential Trough, a Ridge, a Partition, a three-dimensional Window and a Troughs-Ridge and a Troughs-Ridge-Partition and a three-dimensional Window(s), as FESD forms;

A Nozzle form, local and highly directional spouts as FESD forms;

A globose End 2, a globose inverse First End, a PPLD counterpart band form, as FESD forms;

A Bridging Wall with Domed Cavities about an Inlet, as FESD forms;

A version of a Fin, as FESD form;

A Trough, a Ridge, a Partition with/without a version of a Window, as FESD forms

A Trough inside a Trough, a Troughs-Ridge, a Troughs-Ridge, a Troughs-Ridge-Partition with or without a version of a Window, as FESD forms;

Cavities and dome Cavities, as FESD forms;

A rounded, a flared, an Infant Boot, a Fin and an End 2 or a First End, as FESD forms;

A Dimension(s) 44, (44, 44′) a version of a migration of forms, as FESD forms;

A pitched basin a crescent and an annular valley and a rounded form, as PPLD FESD forms;

A version of Sub-outlets forced lower hydrostatic pressures, a DCSS and a GC cross-sectional areas and forms, as FESD forms.

A quanta conforming least mass fluids composition that comprises a highest elevation, a least height, fluids globose volume least length compact composites naturally free surfaces and quanta mass energy least rotations, GC Universe a least height boundary and minima surfaces, optimally conserve fluids energy; a conforming embodiment, a quintessential core natural disposition mass energy highest conserving (MEHC), a genome, compact composite of forms completely matched complete complements constitute a GC Set, a Fluid Element, forming an inflow Inlet, a basin and an outlet, enclosing fluids said quanta, whose fluids flow comprises quantum concurrent paths of passage (PP) with a lengths least sum, a PPLLS, constituting a path angle of passage, a PAP line, and a basin outlet lowest surfaces path, a path of passage of least energy demand, a PPLD, with a PPLD band width with PPLD forms, and fluids an upper retention submerged an Inlet lower end, a globose End 2, or a globose inverse First End undersurface, in a transition region; said Inlet has an upper end, an End 1, a lower end, said End 2, or ends in a Set basin form that houses said First End; said Inlet End 2 or said outlet First End fluid outflows comprise said fluids quantum masses steady transports, along optimally short height and length slopes, narrow width PPLD bands, and conduit breadths embodied forms complement; manipulated cross-sections varied areas complete complement breadths force highest densities fluids highest elevations, ahead of said fluids quanta globose conforming least mass, large free surfaces and under uniform atmospheric and restrained hydrostatic pressures fluids dynamic flows; a quanta fluid higher densities transporting, with said forms raised fluids centroids, constitute said forms and least length, a short right-of-way, through at least three manipulated cross-sections, modulating areas; a Set complete complement breadths, constitute complete globose open channel large free-surface forms of least perimeter, height, and quanta mass rotations, a PAP Line angle less than 180°, and a Flush Apparatus maintained FESD forms; globose conduit functions make a much smaller fluids quanta said Set or forms than those of the prior art; said End 2 or First End a sidelong to an anti sidelong locality creates domain and Sets; crossing a globose with a circumferential strain effects a hybrid domain; GC forms, globose composite complete complement breadths enclose a first Fluid Element, a lower conduit, a wider transition region, with globose cross-sections upper forms yet wider breadths; a Flush Apparatus, parts pre-molded in walls, adeptly flush, sterilize and/or coat surfaces; said (GC) globose conduit Universe forces natural disposition Sets infinitesimal to infinite quintessential, core, mass energy highest conserving (QCMEHC) conforming, functional two globose and conforming two conduit fluids quanta mass energy unique perimeters, synchronous four perimeters complete complement coincident boundaries, two genomes rudimentary Fluid Elements analogous to Atomic Elements; universal MEHC genres embodied analogies, with atomic elements, applied to nonhomogeneous, nonuniform and unsteady fluids, specified and illustrated said Sets, forms, and domains describe. Said MEHC forms and genre apply accurately to homogeneous, nearly homogenous, or elevated pressure fluids in drainage lines and piping, wherein entirely round cross-sections are correct and widely utilized, such as with rinsing or flushing fluids and dishwashers and in general equipment discharges; thus, continuation in part is continuing from the first application, including the Patent and illustrated figures, especially FIG. 1 and FIG. 12. Said Set structures genres embodied MEHC superimposed on the Patent Set yields said Patent flexible tubing precise curvatures and positions of positioning members. In fact, herein FIG. 2 does that positioning and configuring for any fluid composition and for similar forms comprising a Set, including the Patent. Continuing in part, the Patent figure is mute and redundant effort; it is included in said FIG. 2; with equipment utilization and said fluids, the cross-sections that MEHC mandates requires an entirely rounded form; action that converts a cylindrical to a globose Set and forms and vice versa includes MEHC said genres.

The text and claim correlate forms and MEHC, forms equal function, functions equal forms, said domains, Sets and forms governed by the science Laws of Mass and Energy Conservation, which said configurations specified nearly infinitesimal details, mechanics of forms, herewith, describe.

The prior art utility domain patents embody en masse failing function residents comprising failed residents' domain, human forbidden mechanisms. A simple trap short longevity confirms that all prior art patents dwell in a failed domain. FIG. 1A and FIG. 1B respectively compare said GC Set and simple trap forms; provided references disclose simple traps: a) 2.5 times greater fluids mass retention; b) 5 times greater fluids mass interface surface perimeters; c) at least 2.25 times higher operating pressure; d) at least 2 times higher lift for one retained fluids mass turnover, with outlet extremely high back pressure; e) friction at least 11.25 times greater, b times c; f) at least 5 times more energy required, said c times d (for outlet comparative GC Set with FESD detailed versions many times greater); g) flows large friction angle directional changes, resulting in 3-90° elbows. Said Figures show, GC Set and simple trap structures PAP, PPLD lengths, energy demand visual comparisons, with simple traps PPLD more than twice as long, twice as deep and long enough to cause retention mass directional reversals due to latent responses of fluctuating fluid inflows and thus outflows, with energy losses of conflicting directional flows; said Set comprises a PAP Line a short linear length and a rotational angle of 108°, graphical representations of a rotational and a liner respective fluids energy usage, as functional energy required; see pg 27, Line 7 to pg 34, for said genres energy and forms and pg 33 summary; said simple trap makes a broken curvilinear or discontinued PAP Line length with a PAP angle in excess of 180°; said short length GC Set, with outlet FESD forms low back pressures, has least or no such energy losses; with said GC Sets low energy usage, the prior art simple traps utilized exponentially more fluids energy; GC Set genres lower exponentially fluids demanded energy utilization; also, in the following text to pg 34. Said simple traps structure curved perimeter comprises structural Z property constituted peak stresses, bending moments, FIG. 1B noted, Points B and C. Said GC Sets embody preferred hoop stresses. The two function in different genus: the GC-Sets in conduits, said traps in a digestive tract genus.

Said MEHC GC Sets' forms constitute coincident perimeter boundaries more rare than diamonds—four functions: 1) fluids conforming least quanta; 2) said transition region submerged; 3) a high fluid densities transporting; and 4) fluids MEHC. Said four functions subdivide into globose and conduit functions, by taking mainly two of the four—conduits: 1) said MEHC; 2) said submerged transition region transporting fluids; for globose forms: 1) said MEHC least quanta; 2) processes, with or no stratifications, transition region submerged; said processes GC three functions include globose conduit forms mass units, MEHC versions, twelve directional and six rotational motions, constituting globose and conduit finite elements 18 motional responses, for a 72 responses tensor.

Nonuniform, nonhomogeneous, and nonsteady fluids MEHC processors mass energy transport in drainage lines said four functions, conduit forms equal functions, embody mass energy first Fluid Element; and, it is said Fluid Element, since it embodies maximum mass energy within perimeter of that mass as the atoms do. As long as said perimeter boundaries MEHC embodied fluid flows exist, no other Set will utilize less energy in transporting that mass energy. Said Sets embody the fluids next Fluid Element, in said globose fluids form MEHC constituting a submerged transition region surfaces, comprising said compact quanta conforming least mass a paramount factor, with globose perimeter boundaries which contain, detain, retain, transfer, and transpose compact mass within Sets and forms MEHC forms genus, exemplified by atomic elements and celestial bodies functions equal forms; said Sets and forms embody MEHC genus second, next to the first, Fluid Element; fluids GC forms possess quintessential core mass energy MEHC transport, a functional modifiable conduit Inlet within said Set MEHC genus domains, in ND atmospheric and very low hydrostatic pressures open channel flows, with much lower fluid pressures than in any other trap; algorithm computing streamlined Sets, PPLLS and forms FESD configurations, transition region optimal globose quanta conforming least mass and PPLD band PP Line least energy of distortion sustain longevities; Flush Apparatus assemblies that complement GC Sets the drawings illustrate.

In an analogy to atomic elements, said Fluid Elements mass energy includes these energy genres: Nonhomogeneous, nonuniform, and nonsteady fluids uniquely configure GC Sets Universe from genus parent, whose schematic cross-sectional view taken about a PAP Line symmetry the FIG. 1 shows; the parent perimeter contains fluids potential energy to configure Inlet, outlet match, with ample energy, consistent with PPLD band form energy genres an open mouth inflow (not shown) or a least height Inlet with basin outlet configurations of GC Universe Sets; a globose Inlet End 2 or a globose-inverse outlet First End migrations from a basin-outlet blind side to the opposite end anti-sidelong locations constitutes Sidelong, Sidelong Offset, Offset Centric, Centric, Anti Offset Centric, Anti Sidelong Offset, and Anti Sidelong Sets and forms with upright, low angled, angled to near upright, angled, industrial, Inline, inverse, hybrid, migrations, and mutations domains and genomes of globose Sets of Fluid Elements Universe; the Universe evolves from said parent with open mouth inflow Inlet, basin and orifice outlet comparative form to atoms and celestial bodies;

Ser. No. 09/850,927 depicts said parent as originator of said Sets, forms, and Universe, wherein each domain GC Sets and forms, said PPLLS and MEHC Fluid Elements versions embody a genome;

Said conforming GC Sets quanta conforming least mass quantum units of mass constitute MEHC finest elements algorithm kinetic and potential and energy modes sum, PPLLS, including upright paths gravity acceleration multiple, making fluid retention perimeter low height forms; these four generic claims: 1) GC embodiments; 2) a conforming least quanta subdivided into quantum units concurrent PP, a PPLLS; 3) a curvilinear PPLD; and 4) a PAP Line, an angle less than 180°, with the priority data, Fluid Elements, atomic structures, neutrons, protons and electrons relationships;

The generic claim 1, GC embodiments, Fluid Element Sets embody fluids version of said MEHC comprising least energy of distortion stresses and strains, said globose Sets and forms domains, a conforming least volume fluids retention structures symmetry about the PAP Line vertical plane;

The generic claim 2, PPLLS, a quanta concurrent quantum paths of passage least sum constitutes quantum all concurrent paths, inside a fluids detention and said retention and said Sets and forms structures, with optimally computed entire fluids mass energy utilization, to a selected finite unit;

The generic claim 3, PPLD band length, including discontinuities, constituting an entire length of the band forms on a Set basin and outlet forms lowest surfaces upon which the band resides; said band length constituting graphically energy required, above that illustrated by the PAP Line, and comprises fluids energy needed capacity, to preclude a progressive failure potential initialization;

said generic claim 4, GC Set and forms PAP Line and angle comprise a retention and a transition region vertical plane of symmetry, a tangent line with no intersections, to the Set PPLD band and a tangent line to a globose End 2 or a globose inverse First End, constituting less than 180° angle, in respect to the gravity direction; said Set and forms PAP respective angle, line length illustrates fluids quanta approximate, rotational, linear energy, including gravity direction components, thus a total energy consumed by said Set structures, PAP Line illustrating graphically energy utilized;

MEHC Universe GC organic cell Sets include a mouth Inlet and an orifice outlet one cell form, a topic in the priority data revealing the Theory of Everything resolution and MEHC longevities; a least graphical separation between a Set PAP Line and a PPLD band is most preferred, for such a forms Set requires a least fluids energy reserve capacity that avoid a potential progressive failure.

Said Fluid Elements described, illustrated embodiments include GC Sets and forms these genres: a person skilled, in construction technologies and skilled in fluids algorithms computer modeling of genres, constituting specified said Sets, forms and genres of said Fluid Elements' illustrations; said illustrations description may serve to verify Sets and forms which are optimally determinant, to finite elements resolution that is said quantum mass genre, which constitutes enormously more precise structures than are those of the prior art. Said MEHC and least energy of distortion make cause and effect relationships; said energy of distortion constitutes totted up respective multiples of stresses and strains. Thus, said Sets and forms, in reality, are optimal longevity structures that for a construction materials selection embody inherent Sets with forms optimal longevity genres;

Referring to the drawings, the inventions GC MEHC Universe said generic claims energy evolve or devolve conforming embodiments, globose and globose spherical and cylindrical fluids quanta height less than two diameters. Unique origin fluids forms rotate, mutate, transpose, and transfer into Sets, hybrids and domains that the applications exemplify, especially the Ser. No. 09/850,927; an inflow Inlet, a globose perimeters enclosure with an outlet (basin outlet), rudimentary Sets, Fluid Elements, a globose Inlet End 2 or a globose inverse outlet First End, which migrate from a basin one end to the opposing end, constituting these Sets: a Sidelong, a Sidelong Offset, a Centric, an Offset Centric, an Anti Offset Centric, an Anti Sidelong Offset, and an Anti Sidelong, with basic forms, and: an upright, an angled to near upright, an angled, an Industrial, a low angled, an Inline globose and globose inverse Sets and hybrid Sets migrations and mutations and domain genomes of GC Universe Sets with forms, atomic elements analogous, Fluid Elements, GC PPLLS MEHC said versions, taken analogously, as mass energy conforming Sets, Isotopes, and Ions, and forms. Retention mass horizontal plane rotated about a Set upright axis, especially Inlet axis comprising free surfaces raised horizontal is an upright Set and a wobbly raised free surface is an angled Set;

Said GC MEHC optimal PPLLS energy forms embody enormous advantages: a) even with open mouth Inlets, single cell organisms evolved and are highly functional; b) said outlet DCSS a First Sub-outlet, in a rounded cross-section greatly narrowed breadths, can pass a largest particle, raise initially a hydrostatic pressure, while assisting to restrict it, to positively submerge said transition region crucial undersurfaces; a Second Sub-outlet and a Third Sub-outlet enforce low hydrostatic pressures, making cross-sections upper portions for a positive connection to a vent line stack that avoids suction and forces said ND open channel flow into a drainage line; c) said low hydrostatic pressure lowers friction or energy of distortion passed into boundaries, retaining greatest velocity flows; d) said Fluid Elements, GC cross-sections with optimal Inlet least height, constitute a least energy of distortion, hoop stresses, in boundaries, for optimal longevities; e) said Fluid Elements utility functions pass nonhomogeneous, nonuniform and nonsteady fluids yet preclude suction or venting, by globose forms conforming least mass sealed undersurfaces and boundaries, with least pressures and frictional losses; f) shortest, shallowest PPLD forms and paths, FIG. 1A illustrates; GC conforming embodiments PPLLS, PPLD upper sections-sections that are much greater, up to a vent stack connection, than the Inlet cross-sections avoids suction; lower conduit cross-sections area constitute narrow breach rounded lower surfaces PPLD narrow widths and short and gradual slopes, for high density fluids flow and transition region submerged crucial undersurfaces; thus a lower GC form includes conduit spout cross-sectional area forms that extend PPLD band widths, constituting a lower conduit form, to a globose End 2 or a globose inverse First End undersurface horizontal, radial, and infinitesimally highest increment; a lower conduit comprises lowest cross-sectional areas region from a PPLD form to said areas nearly half-circular form springing points; a transition region widens a breadth of the lower conduit springing points into GC upper globose forms cross-sectional area springing points; the lower conduit and transition region make upright plane symmetric forms; a detention fluid includes fluids above a retention or a summit elevation; an upper retention constitutes fluid above a highest portion of either a globose End 2 or a globose inverse First End undersurfaces with no reliance on a fluid mass surface tension and/or adhesion; a summit constitutes: an outlet ascending spout, a horizontal infinitesimal width of a PPLD band, said band width a highest infinitesimal increment also furthest from a respective Inlet, and a fluid tension and adhesion height higher than an upper retention free surface elevation at-rest, and thus retention, constituting a discharge cross section surface (DCSS) lowest horizontal finite part; said retention is taken as retained mass fluids level at rest, no higher than an elevation of said summit; a Set and forms PAP line comprises fluids retention vertical plane symmetry, a tangent line, with no intersection, to its PPLD band, and concurrently a tangent line to a globose End 2 or a globose inverse First End, constituting a PAP line angle less than 180°, in respect to the gravity direction; said GC basin outlet upper retention embodies largely a truncated form of these five: a globose, a cylinder, a spheroidal, an ellipsoidal or a cylindroid, with a height less than a dimension of basin; Said globose End 2 or globose inverse First End undersurface is disposed proximate of a ½ half of said lower retention height and lower conduit form, with narrow breadths, transporting highest density fluids; including PPLD forms, said breadths modulated cross-sectional areas, constituting a Set that transports a nonhomogeneous, nonuniform and unsteady fluids mass, embody a highest densities mass centroid higher elevations than in an Set with equivalent entirely round area cross-sections, comprising said mass centroid PP that is more crucial than said PPLD; transporting said mass centroid, transports all of highest density mass through said lower conduit; said centroid PP constitutes a shallower and a shorter length than said PPLD, wherein said mass centroid transport constitutes a lower energy demand, said PP and PPLD lengths correlated; said PPLD widths with conduit breadths, by forms equal functions and vice versa, in said GC Sets and conduit lines, said rudimentary Fluid Elements, for nonhomogeneous, unsteady, and nonuniform cross-section areas fluids mass transports, constitute optimally least energy usage and energy demand cross-sections;

A PPLD band length, including band length all discontinuities, corresponds to an entire length of said band on GC Set basin and outlet forms lowest surfaces length upon which said band resides.

A Set PPLD band and a globose End 2 or a globose inverse First End undersurface taken tangent line, comprising PPLD band symmetry, constitutes a PAP line of said PPLD band and Set forms;

An End 2 Nozzle forms FESD constitutes an integral part of said submerged End 2 undersurface; Fluids conforming quant mass said outlets include Sub-outlets, DCSS, PPLD bands FESD forms, and forms least slopes: in a small rounded lower conduit, a transition region, and a globose upper region perimeter version(s) of these: a rounded, a curvilinear, an elliptical, and a parabolic forms; said Flush Apparatus assemblies and parts inside walls of a Set, with planed fluids tie-inn access, to most or all locations, separately or concurrently disinfect, flush, coat repair or protect sound or damaged surfaces; said Flush Apparatus prefabricated and pre-assembled surface locations a Set, a nozzle, a set or a network of nozzles, with a tie-in or a tie-ins set disposed about a Set, dispense design liquids, air, gases, jointly or individually, to separate sequences, intervals or concurrently; said Flush Apparatus tie-in assemblies check valves can act as controllers of air and design fluids inflow into a Set, to counter suctions through said single or networks of nozzles, and/or as device sensors of basin low fluid level to initiate air and design fluids inflow, enforcing fluid elevations.

There exists a direct correlation between said advanced Processor, advanced Fluid Elements, and said second Fluid Element; the correlation between the two is that utilized in the integral calculus to summarize finite increments total effect over the ranges of the variables; said elementary Fluid Elements, the second Fluid Elements, constitute gravity sink force two directional ranges, one up and one down. Said advanced Fluid Elements have six, two for each of the three directions. The correlation between QCNDMEHC, QCMEHC, MEHC and MEHC is apparent; they are versions of MEHC. The perimeter boundaries said correlation between said advanced Processors and that of said second Fluid Element is that correlation of the same genre of said MEHC versions, which force said perimeter boundaries. The Laws of Mass and Energy Conservation guarantee that said correlation between said second Fluid Element and said advanced Fluid Elements will hold in all functions, revealing that said MEHC versions include differences that become apparent with said perimeter boundaries forced longevities. Reverting to sciences said integral calculus correlations reveals that the second Fluid Elements, by constituting said second Fluid Element genres optimal perimeter boundaries longevity, constitute three dimensional units cell elements of said advanced Processor with finite to infinitesimal accuracies; magnetosphere deformations and magnetic field line disconnects, plasma outflows, Coriolis Effects, pg 7 Line 8, and Fluid Elements free surface, pg 15 Line 1-4 confirm that said correlations accuracy holds, to an infinitesimal increment detail;

Said correlations embody enormous significance; functions of light fluids are traced from infinity of space to an infinitesimal detail of a rudimentary Fluid Element and constitute referenced, prior applications, and especially herein, revelations of said FEIIPMII technologies. Furthermore, said FEIIPMII technologies reveal that elementary to advanced Fluid Elements, light atomic elements based fluids crucial functions and processes which resolve the Universe three Principal Theories, by implementing light based fluids revealing technologies sustain coexistence of this civilization; significantly, the magnetosphere longevity relies on sustenance of said light fluids magnetic lines that, in turn, depends on energy of distortion with light fluids densities in magnetic field lines. In said enormous significance, said correlations importance stands out, by accentuating said Earth's magnetic field chronic failures history: twenty wipeouts, at least three changed dispositions, with over 1500 climate changes. Said Earth's geology history and said astronomy revelations confirm that the Earth suffers progressive failures phenomenon, causal effects of Black Holes' light fluids energy demand, now lacking crucial light fluids mass. Elementary Fluid Elements energy genres reveal that phenomenon which verifies that greenhouse gases—specifically CO2—comprises very transient global air warming catalysts; said Universe functions and processes light fluids demand excludes CO2 gas as a component. Herein, technologies reveal root causal effects of natural and AGW global warming, groundwater depletions, and energy crisis, and constitute real resolutions. The entire prior art opposes the Earth's natural functions, thus assisting said Black Holes suction.

### BRIEF DESCRIPTION OF THE DRAWINGS

The Summary and claims major part, said Universe processes, establish natural and AGW global warming, groundwater depletions, and energy crisis root causal effects highlighted resolutions on pg 33; the rest of the Summary with claim 10 specifies elementary, rudimentary, Fluid Elements.

The invention principles, that the specifications describe and disclose and the drawings illustrate, are not limited to the illustrated examples. Having a drawing, one could make modifications and vary figures of the same and not depart from the scope of the inventions that make this Universe; Said principles technology and inventions are susceptible to variations; the specifications specify and drawings illustrate a limited number of Sets, as exemplifications only of said Fluid Elements.

FIG. 1 of the drawings shows an inorganic Second Fluid Elements genus genome cross-sectional view of a Globose Strain genus generally taken about its upright plane of symmetry of a globose conduit and not shown an Inlet, parent of Fluid Elements, and a version of organic single cells genus parent. FIG. 1A of the drawings shows a Globose Genus Fluid Element invention schematic of a cross-sectional view generally about a PAP Line upright plane of symmetry;

FIG. 1B of the drawings shows the prior art simple trap cross-sectional view schematic generally about an upright plane of symmetry;

FIG. 2 of the drawings shows a Globose Sidelong Fluid Element 10A invention cross-sectional view generally taken about a PAP Line upright plane of symmetry showing a rounded End 2 and a PPLD band rounded lowest surface form FESD forms, inventions;

FIG. 3 of the drawings shows FIG. 2 invention sectional top view taken generally about Line A-A; FIG. 4 of the drawings shows a Globose Sidelong Circumferential Fluid Element invention cross-sectional view taken generally about a PAP Line upright plane of symmetry, with: a Trough, an Infant-Boot End 2, a PPLD band rounded lowest form, and a Fin FESD forms, inventions and a Flush Apparatus assembly invention;

FIG. 5 of the drawings shows a Ridge FESD invention cross-sectional view taken generally about Line C-C of FIG. 4;

FIG. 6 of the drawings shows a Trough FESD cross-sectional view taken generally about Line C-C of FIG. 4;

FIG. 7 of the drawings shows a Globose Centric Fluid Element invention cross-sectional view taken generally about a PAP Line upright plane of symmetry showing: an Infant Boot End, an Inlet centric Conical Form, a PPLD lowest annular valley, and a Bridging Wall FESD forms, inventions and a Flush Apparatus assembly invention;

FIG. 8 of the drawings shows a cross-sectional view of a Bridging Wall FESD invention taken generally about Line CCC-CCC of FIG. 7;

FIG. 9 of the drawings shows a cross-sectional view of a Bridging Wall FESD invention taken generally about Line C-C of FIG. 7 Fig;

FIG. 10 of the drawings shows a cross-sectional view of a Bridging Wall FESD invention taken generally about Line CC-CC of FIG. 7;

FIG. 11 of the drawings shows a Globose Centric Fluid Element invention cross-sectional view taken about a PAP Line upright plane of symmetry showing: an Infant Boot End 2, an offset Conical Form, a PPLD crescent, and a Bridging Wall FESD forms, inventions, and a Flush Apparatus assembly invention;

FIG. 12 of the drawings shows a Globose-Cylindrical hybrid Offset Centric Fluid Element invention cross-sectional view taken generally about a PAP Line upright plane of symmetry showing: a Trough inside a Trough, an Inlet Flared End 2, an Inlet centric conical form, and an annular valley PPLD FESD forms, inventions, and a Flush Apparatus assembly invention;

FIG. 13 of the drawings shows a sectional top view taken generally about FIG. 12, Line C-C,

FIG. 14 of the drawings shows a Globose Centric Cylindrical Fluid Element invention cross-sectional view taken generally about a PAP Line upright plane of symmetry showing: a rounded End 2, a conical form, a PPLD annular valley, an elliptical upright major axis outlet First End, and a DCSS, FESD forms, inventions;

FIG. 15 of the drawings shows a Globose Inverse Centric Cylindrical Fluid Element invention cross-sectional view taken generally about a PAP Line upright plane of symmetry showing: a rounded First End, a conical form First End centric, and a PPLD annular valley form, FESD forms, inventions;

FIG. 16 of the drawings shows a top view of a Globose Inline Centric Fluid Element invention of the FIG. 17 invention;

FIG. 17 of the drawings shows a Globose Inline Centric Fluid Element invention cross-sectional view taken generally about a PAP Line upright plane of symmetry, with: an Inlet about an inner Inlet flared rounded End 2, a PPLD annular valley, and an outlet DCSS FESD forms inventions;

FIG. 18 shows a Partition FESD of a Cylindrical Inline Centric Fluid Element invention cross-sectional view taken generally about an upright plane orthogonal to the FIG. 17 cross-section;

FIG. 19 of the drawings shows a Globose Angled Sidelong Fluid Element invention cross-sectional view taken generally about a PAP Line upright plane of symmetry, showing: a curved Inlet End 2 and a counterpart filler member PPLD form FESD forms, inventions, and a Flush Apparatus assembly invention;

FIG. 20 shows a Globose Angled Sidelong Fluid Element invention cross-sectional view taken about a PAP Line upright plane of symmetry, showing: a curved Inlet End 2 and a rounded surface of a basin filler member PPLD crescent FESD forms, inventions, and a Flush Apparatus assembly invention;

FIG. 21 of the drawings shows a Globose Inverse Angled Centric Fluid Element invention cross-sectional view taken generally about a PAP Line upright plane of symmetry, showing: a First End and a basin filler member PPLD rounded FESD forms, inventions, and a Flush Apparatus assembly invention;

FIG. 22 of the drawings shows a Globose Inverse Angled Sidelong Fluid Element invention cross-sectional view taken generally about a PAP Line upright plane of symmetry, showing: a First End and a filler member PPLD annular valley FESD forms, inventions, and a Flush Apparatus assembly invention;

FIG. 23 of the drawings shows a Globose-Inverse Angled Sidelong Fluid Element invention cross-sectional view taken generally about a PAP Line plane of symmetry with: an anti sidelong Inlet End 1, a First End, and a filler member rounded PPLD FESD forms, inventions, and a Flush Apparatus assembly invention;

FIG. 24 of the drawings shows a Globose Angled Centric Fluid Element invention cross-sectional view taken generally about a PAP Line plane of symmetry showing: an anti sidelong Inlet End 1, a First End, and a filler member annular PPLD FESD forms, inventions, and a Flush Apparatus assembly invention;

FIG. 25 of the drawings shows a Dual Globose Sidelong Hybrid Circumferential Fluid Element invention cross-sectional view taken generally about a PAP Line plane of symmetry, showing: a Fin End 2, a Fin, and a Fin Partition FESD forms, inventions, and a Flush Apparatus assembly invention;

FIG. 26 of the drawings shows a sectional view of a Partition FESD form, invention, taken about Line C-C of FIG. 25 invention;

FIG. 27 of the, drawings shows a cross-sectional view of a genome of conduit genus parent of nonhomogeneous, nonuniform and nonsteady and first Fluid Elements, inventions;

FIG. 28 of the drawings shows a sectional view generally taken through a circumferential basin outlet of a Circumferential Genus strain second Fluid Element invention;

FIG. 29-31 of the drawings shows a cross-sectional view taken generally about a PAP Line plane of symmetry of three versions of Flush Apparatus networks and assemblies and parts, inventions;

FIG. 32 of the drawings shows a cross-sectional view taken generally about a PAP Line plane of symmetry of a Globose Industrial Centric Cylindrical Fluid Element invention, three Sub-outlets FESD forms, inventions, and a Flush Apparatus assembly invention;

### DETAILED DESCRIPTION OF THE DRAWINGS

The Summary and claims major part, said Universe processes, establish natural and AGW global warming, groundwater depletions, and energy crisis root causal effects highlighted resolutions on pg 33; the rest of the Summary with claim 10 specifies elementary, rudimentary, Fluid Elements.

Supra advanced Processor boundaries comprising magnetic field shielded quanta mass functions, embodied said FEIIPMII universal GC Sets, stratifications and gradations forbidden mechanisms processes that relate to said decoupling processes are better understood with accompanying brief descriptions of presently illustrated Fluid Elements' inventions, with: a) said advanced Processor boundaries processes are those of the Earth's fluids mass said energy sink and the magnetosphere forms equal functions or vice versa and b) Sets of a Second and a First Fluid Element inventions.

Said inventions, technologies, principles are susceptible of variations. The specifications specify and drawings illustrate limited number of Sets, as exemplifications only of the GC Sets Universe.

The invention principles, that the specifications describe and disclose and the drawings illustrate, are not limited to the illustrated examples. Having a drawing, one could make modifications and vary figures of the same and not depart from the scope of the inventions that make this Universe;

Genres of first Fluid Element forms comprise pg 30, Line 29 to pg 31, Line 3 said lower conduit, said wider transition region, with even wider upper globose area cross-sections, including FIG. 27 described illustration; said first Fluid Element genres constitute portions of second Fluid Element Sets numerous outlet cross-sections, apparent in crucial DCSS forms, as in the FIG. 13 or FIG. 18. Said first Fluid Element forms energy genres are Fluid Elements genres, including nearly parallel said PAP Line and PPLD band. Second Fluid Element Sets, FIG. 23 and FIG. 24, show such PAP PPLD genre. Said lower conduit narrow breadths elevate a centroid path of higher density fluids and said globose and transition region wide breadths lower centroid paths of lighter fluids, with a PAP Line approximate half sum elevation of said two paths, comprising the Fluid Elements least differences between said energy usage and energy capacity required, which minimizes potentials of progressive failure and validates said Fluid Elements perimeter boundaries as optimal devices. See, pg 26, Line 13 to pg 34, said GC energy and forms genus genres and technologies summary. Said Inlet End 1 and descending outlet spout Second End Exhaust connect positively a respective fluids source with a conduit drainage line that includes a venting stack; connections are generally threaded, welded or compression couplings, positively affixing one of said Set to said source and a drainage line; with or without gaskets, washers, bushings, treaded nuts, and double nuts or lock nuts or such suitable, generally with or without a piece of a flexible tubing complete connections; optimal quality in fabrication moldings tolerances at high pressures and plastics, composites, and metals or semi-rigid materials, adequately rigid or stiffened or a combination of the above, which requires minimum of basic tools with generally hand installation constitutes said Sets fabrication.

A Second Fluid Elements Set entirely rounded cylindrical Inlet optimally short height, elevations difference between said End 2 and End 1, and PPLLS, PPLD band, PAP Line, and Set forms and energy genres enforce said complete complements of forms. Said End 2 or upright Inlet position inside basin reveals domain forms kind. Cross-sections and DCSS forms comprise First Element forms and energy genres, FIG. 27 described. Cross-sections of said Exhaust are entirely rounded.

Fluids inflow into Inlet End 1, pass through said GC basin outlet, to outflow through the Exhaust and flow mainly through said GC Sets lower conduit, pushed by detention's hydrostatic pressure; dual walls with space in between, including gravitational direction compliant tubing, warns of an eminent failure with immediate drips, wherein said walls also represent a part of Set's longevity. Specific locality disposed one-way air nozzle substitutes for said venting stack, avoiding suction;

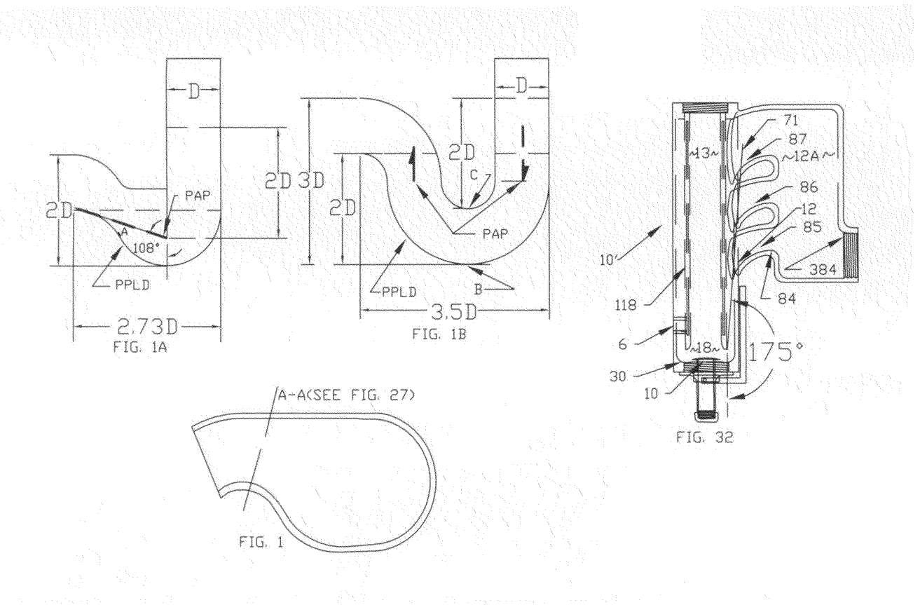

FIG. 1 of the drawings shows a cross-section side elevation view taken generally about an upright plane of symmetry of a visualized GC Universe genus parent that may include Ridges, Partitions, and Troughs and FESD forms, outflows and inflows control through globose basins or single cell passages of nonhomogeneous, nonuniform and nonsteady fluids conduit and/or cell forms, which orient and rotate configurations; Section A-A almost never shows rounded entirely cross-section; that belongs to uniform, homogeneous fluids, naturally nonexistent. FIG. 27 shows Section A-A, of a nonhomogeneous, nonuniform, nonsteady, fluids conduit cross-section of said First Element. Said genus parent constitutes fluid energy facets of GC Universe forms nearly infinite matches of Inlets and outlets about its perimeter, including an open mouth Inlet inflow. Said genus parent is showing an elongated outlet that can reduce to an orifice form, as with one cell living organisms.

FIG. 1A and FIG. 1B of the drawings, approximately to scale, show a side elevation view of a GC genus Set and a simple trap schematics, illustrating fluids quanta volumes structural forms and, a PAP and a PPLD and line forms and energy genres comparatively described in the Specification, see pg 26 Line 18 to pg 27 Line 13; said GC Set genus uses exponential lower energy magnitude; see, pg 26, Line 13 to pg 34, Fluid Elements genus forms, energy genres and compiled summary.

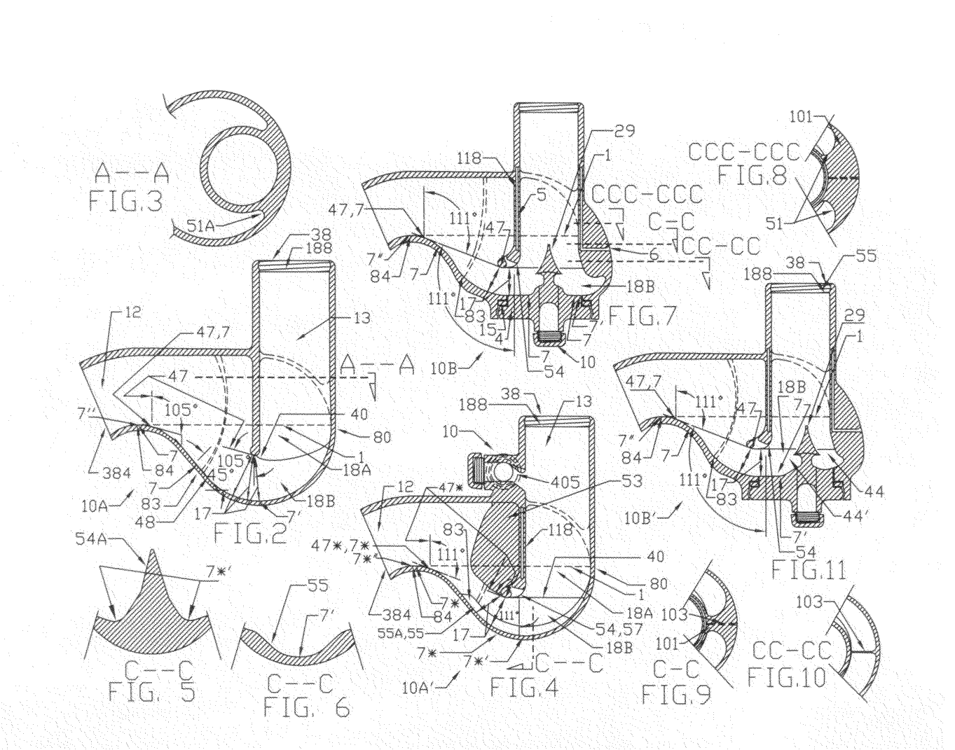

The second Fluid Element genus with Sets and domains is susceptible of numerous FESD forms. FIG. 2-3 of the drawings illustrates a second Fluid Element Globose Sidelong Set that constitutes inflow annular rounded form upright Inlet 13 and said globose 40 End 2 and upper end 38 End 1. Said Inlet comprises a least height form that is granted by said PPLD energy genres. A GC basin 18A 18B outlet 12 nearly hemispherical form embodies conforming least fluids mass, submerges globose End 2 and optimally shortened PPLD 7 band merged narrow widths S form length with a rounded lowest 7′ form; said basin outlet, revealing fluids spout form of genus parent, constitutes lowest surfaces, said PPLD narrow widths band which includes a summit 84, a lowest, horizontal segment of discharge cross-section surface (DCSS) forms. Said GC basin outlet forms constitute an outlet ascending spout and said PPLD band a surface inflection as said outlet 83 First End and said summit DCSS 84 area forms, which initiate said outlet descending spout forms that end with a Second End, an Exhaust 384; said Inlet, nearly hemispherical basin, basin outlet forms embody a narrow breach 51A, on each Inlet side with upper retention shallow depth cross-sectional areas, constituting Cavity 51 A FESD form conduits which merge, as said basin narrows into said outlet conduit ascending spout First End; said End 2 undersurface short height 17 separations from said PPLD band widths lowest surface 7′ form, as a lower conduit portion submerged surfaces in said transition region retained fluids, from said basin blind side with Inlet common surfaces 80 to said outlet summit, constituting free surface 1, fluids retention submerged surfaces. An End 2 portion extending below said fluid retention free surfaces and the other portion constitute with said basin a common surface; said transition region height extends from said lower conduit springing-points elevation to said DCSS widest breadth elevation; said End 2 undersurface comprises short height 17 separations, with said End 2 and PPLD band widths basin lower and side counterpart surfaces crucial FESD forms, constituting said undersurface and PPLD band widths rounded basin lowest forms at highest elevations, initiated by said PPLD lowest form, basin outlet lower surface FESD form; said End 2 portion and said band forms constitute shortest distances to said DCSS. A PAP 47 Line with a 105° line angle in respect to gravity sink direction comprises a tangent line to said End 2 and PPLD band, without an intersection point. Said PPLD band and PAP Line comprise a conforming least mass fluids volume respectively illustrated close, approximate representation of said Set fluids energy demanded to avoid transport progressive failures, required energy utilized, respectively a shortest length of each that graphically illustrate least energy demand, least energy utilized genres. At cross-sections, PPLD band, PAP Line graphical 17 separations illustrate said energy genres difference. A least difference is preferred, as that optimally conserves energy, for said energy demand avoids progressive failures. Said End 1 cross-sectional area is much smaller than other cross-sections. Said End 1 flowing full, under moderate hydrostatic pressures, in turn, causes fluids detention free surfaces rising. Fluid Element forms constitute DCSS cross-sections said lower conduit First Sub-outlet cross-sections area that enlarges, above springing-points, into Second Sub-outlet, up to globose forms springing-points of largest cross section areas Third Sub-outlet forms, constituting First Element cross-sections genre FESD forms FIG. 27 illustrated; fluid inflows through End 1 entire area raise detention free surfaces into said Third Sub-outlet; Outlet forms with a venting line ND open channel flows allow for a large fluids mass transport; said GC basin outlet, Inlet, DCSS and fluids compositions genres optimal free surfaces of GC modulating cross-sections into DCSS subdued fluids transverse rotations and oscillation dynamics constitute FESD forms; said MEHC PPLLS quanta fluids flow quantum concurrent paths include said Sub-outlets optimized complete complements, optimal configuration, of forms. A Fluid Element with optimally minimized PPLLS constitutes genome of its domain Sets. ND Fluids composition that approaches nearly frictionless boundaries approaches QCNDMEHC genres. Said Set illustration shows PPLD highest 48 slope of 45°, PAP 47 Line 105° leg angle and End 2 undersurface profile convex form 17 separations. Energy genres are common across Fluid Elements, forms, Sets, and domains. Fluid Elements are susceptible to FESD forms that optimize complete complements of forms configuration. See pg 23, Line 17 to page 25 Line 3 for listing of FESD forms and effects; see pg 39 Lines 7 to 12 for a Set fluids energy and forms genres complete complements of forms; see, pg 26, Line 13 to pg 34, Fluid Elements genus forms, energy genres and compiled summary.

FIG. 4 Set 10A′, with said upright Inlet 13 basin 18A sidelong disposed, shows these: Ridge 54A, Trough 55, Fin 53, Infant Boot 54 and Nozzle 57 FESD forms and basin 18B and outlet 12 lower surfaces, with Trough 55 or Ridge 54A; said Ridge, Trough Cross-Section C-C, FIG. 5 and FIG. 6 illustrate, respectively. Said Ridge comprises two PPLD said bands that become tangent, passing said outlet First End, without an intersecting point. Each PPLD band 7*′ comprises a hyperbolic form, in top view, which constitutes circumferential strain genre that makes said Ridge that strain FESD form and said Set with Ridge a globose circumferential Hybrid; said circumferential strain distinct Set FIG. 28 shows. A Hybrid PPLD band widths centerline and accompanying PAP Line constitute an upright curved surface; thus, said Ridge FESD two PAP 47* Lines, in vertical plane seen as a line; said Set, Trough FESD form is entirely in globose strain; said Inlet End 2 includes Infant 54 Boot FESD form with Flush Apparatus 10 two tie-ins (capped) and a major nozzle 405. Said Inlet includes said dual 118 walls with an orifice, rather than tubing, disposed at lowest end.

Henceforth not restated: see pg 23, Line 17 to page 25 Line 3 for FESD forms listing and effects; see pg 39 Lines 7 to 12 for a Set fluids energy and forms genres complete complements of forms; see, pg 26, Line 13 to pg 34, Fluid Elements genus forms, energy genres and compiled summary.

Said basin outlet basin centric Inlet disposition comprising optimal configuration, FIG. 7 Set 10B, shows, which further shows PPLD band basin lowest surface annular valley 7 narrowed width 7′ and basin blind side Bridging 11 Wall FESD forms, and Flush 10 Apparatus (capped) with major 405 nozzle disposed favorably in said conical form that is an optional FESD form, optional since without it fluids flows boundary would comprise that form; said basing comprises a Portal 4 Plug with threads in a gasket 15 sealed joint by applied torque; said dual wall comprises said tubing 6. Prior Sets said genres and pages apply. See pg 23, Line 17 to page 25 Line 3 of said FESD forms and effects, and see pg 26, Line 13 to pg 34 for Fluid Elements entire genres compiled summary.

FIG. 8-10 of the drawings shows sectional views of Bridging Wall Cavities 51 FESD forms about FIG. 7 Line CC-CC, Line C-C and Line CC-CC, showing narrow conduit breaches about Inlet.

Inlet disposed centrically in FIG. 11, 10B′ Set, embodies PPLD band widths, pitched basin lowest surface, crescent form, and Dimension 44, 44′ FESD forms; see prior descriptions, pg references.

FIG. 12 Globose ylindrical Hybrid 10BA and said upright Inlet disposed centrically offset shows Trough 32, Circumferential Trough channel 34A, Ridge 86 87, Partition 34A 86 87, oversized 12 forms outlet DCSS Tough-Ridge, Trough-Ridge-Partition, Ridge-Partition, and Flared End 2 and PPLD annular form FESD forms. Said oversized outlet DCSS FESD topside of basin constitutes First, Second, and Third Sub-outlets 85 86 87, connected to said venting stack, precludes suction. Said outlet ascends as a Trough inside two 34A circumferential Troughs FESD form, descending from said basin blind side; said basin form about Inlet embodies circumferential Trough, Trough-Ridge, Trough-Ridge-Partition and Trough-Partition FESD forms; as said Ridge, Ridge-Partition and Partition, with basin outlet upper casing constitute, a three dimensional Window FESD form; Sets and FESD forms energy genres, figures and said pgs detailed, apply equally across domains.

FIG. 13 illustrates top view of Section C-C, taken through said FIG. 12 Set forms.

In Cylindrical Set 10CA, Inlet disposed centric FIG. 14 shows with elliptical cross-sections outlet ascending spout narrow widths of PPLD band FESD forms that extend from basin annular valley lowest PPLD form comprising narrow breaches 44 from Inlet as Dimension 44, 44′ FESD forms. Basin lower casing constitutes a threaded Portal Cap, with gasket forced seal when hand torqued.

Outlet First End disposed centric inside Globose Inverse Centric Cylindrical Set, 10AC Inlet and basin forms FIG. 15 shows, with basin centric annular valley PPLD band widths, First End forms counterpart FESD forms. Preferred versions of outlet, First End, and DCSS forms constitute said First Element cross-section genre forms FIG. 27 shown. Extreme variations in Dimension 44, 44′ transposes centric into respective sidelong or anti-sidelong configuration; outlet spout shows said dual wall assembly; top of outlet crown from can comprise a one-way nozzle, precluding suction.

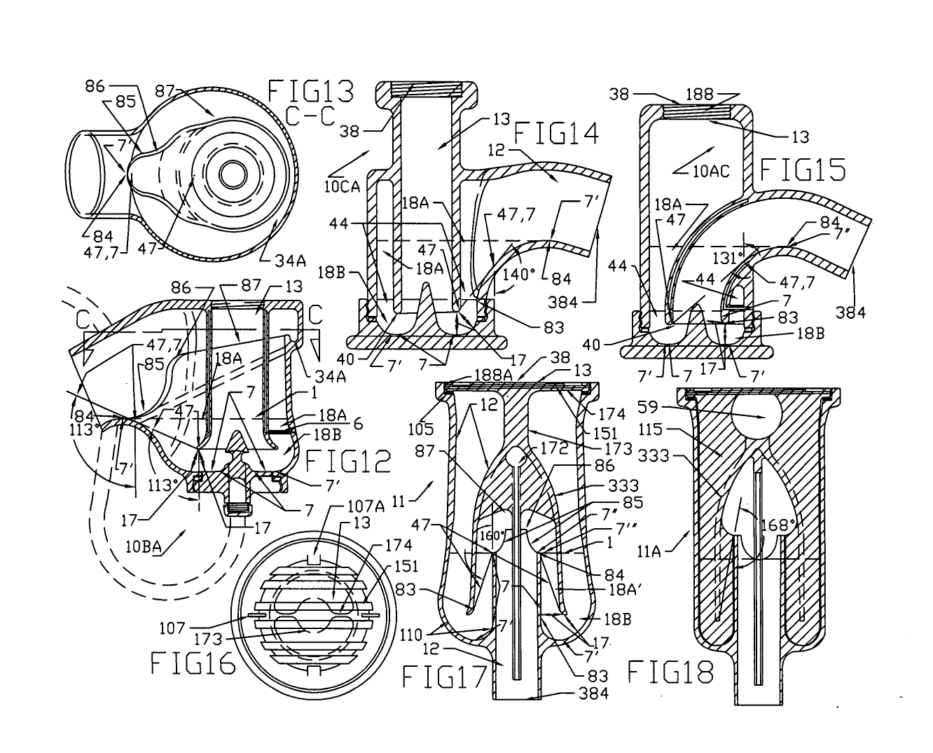

FIG. 16 illustrates top view Inlet forms disposed centrically in basin of Set 11.

Inner Inlet 333 hollow conical mostly surface of revolution Partition form, constituting lower end flared into rounded End 2 form, around upright conduit 12 outlet form FIG. 17 Set 11 shows. Said outlet upper end embodies First Element cross-section genre DCSS forms, with two PPLD bands and PAP Lines, on diametrically opposite sides of Inlet or outlet, in a basin mostly hemispherical form; Inlet, basin outlet complete complements of forms comprise FESD forms; Inlet 12 rounded form, with slight narrowing, extends into a rim of End 1 that fits into an open flange recessed rim that comes with most containers of fluids. Set installation is from above, to seat counterpart rims and silicon seal and secure End 1 rim, by conventional means with fixed assemblies with fittings, under the container. Basin lower surface rounded lower surface valley 110 sides and PPLD band narrow widths comprise a FESD annular form under said End 2, around basin ascending or outlet descending upright 12 spout, constituting successively a narrow, to a wider short radii turn, into a narrower said 17 separations, which constitutes said fluids FESD manger varied velocity through a sharp turn. Said outlet spout and hollow conical form constitute basin decreasing breach cross-sections and into a FESD, primarily a DCSS orifice form yet comprising First 83, Second 84 and Third Sub-outlet 86 three dimensional DCSS FESD forms. Said DCSS FESD three-dimensional surface dwarfs First Sub-outlets areas with two summits 84, PPLD 7′ bands, and PAP Lines; said outlet as a rounded form Partition FESD manager splits ascending spout breach and rising spouts cross-sectional areas into an annular form, narrows otherwise very wide breadths through a large PAP Line angle, and removes a detrimental space below Inlet, constituting said PPLLS complete complements of forms, optimal configurations. Said outlet spout and Sub-outlets embody a three dimensional Partition and said FESD manager of forms breach and annular cross-sectional areas. Said conical form and Inlet 12 likewise constitute an FESD forms manager and said conical form comprising said three dimensional Partition that embodies, on inner and outer faces, FESD fluids manager or manager around manager FESD forms. Disposed centrically inside said outlet spout, upright perforated conduit 171, side plates welded to said hollow conical form, including a space gap 172, constitutes a TD Partition FESD, with perforations as two-dimensional Windows FESD forms that control suctions, constituting said TD Partition inside TD Partition inside TD Partition FESD forms. Said conical form or outlet spout, either one, migrating radially changes respective forms disposition inside basin and forms kind, comprising Set mutations. Angling Inlet or outlet forms similarly change forms kind; Globose Inline Set forms embody numerous domains of Sets. Said conical Partition FESD extends into a round 173 post and a treaded flange 174 that are fixed in place to said End 1 with a brass gasket 105, a strainer 151, and lock keys 107, 107A assembly.

FIG. 18 shows side elevation view generally rotated 90° is respect to the cross-section of FIG. 17 of two dimensional Partition 115 manager FESD form, splitting basin inlet forms into two halves and two-dimensional Partition upper end rounded Window 59 FESD form. Rising fluids level in one of said two halves upon rising in one half of said 11A Set forms outflows into said other half which caps fluids pressure, velocity flows in said half with high fluids free surface; said Partition FESD manager is freely supported by basin lowest surfaces and, in elevation, on each side. Said Window with said post includes sharp and fine rounded edges; by achieved access from above to clean or replace, sets of said mangers that subdivide diametrically said fluids quanta are planned.

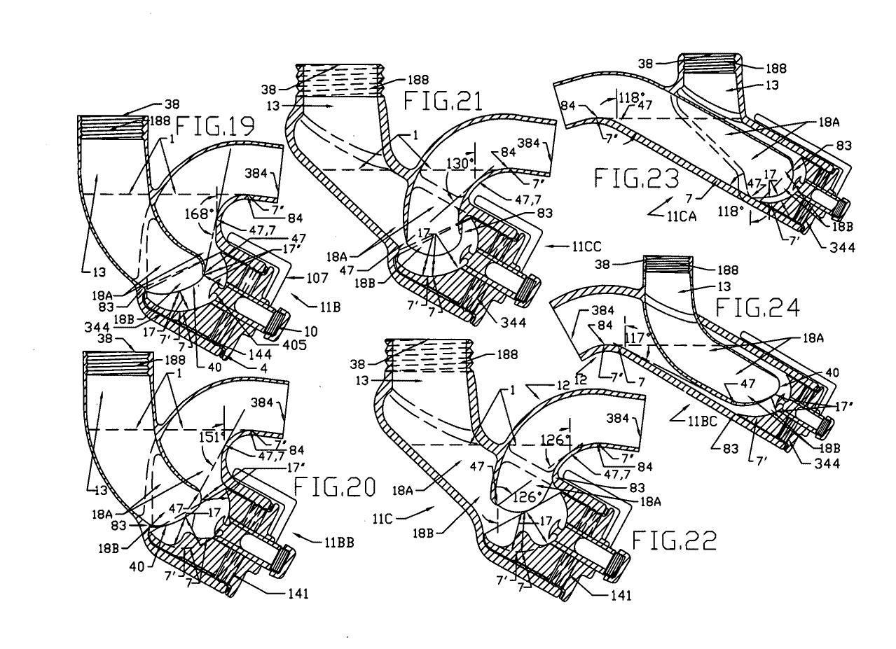

FIG. 19 and FIG. 20 show two Globose Angled Sidelong Sets 11B, each curving from PPLD band lowest widths to a separation of and Inlet and curving outlet spout, comprising an Inlet upper end portion nearly upright, with End 1 cross-sections entirely above fluids free surface at rest entirely rounded form separated from outlet fluids elliptical form free surface by common wall thickness. In respect to said Inlet rotation, said basin outlet counter rotates, including lowest surfaces PPLD forms. End 2 convex profiles and counterpart globose basins PPLD bands lowest widths, by said rotations comprise nearly horizontal PPLD lowest forms, therefore orthogonal to the gravity sink direction; FIG. 19 highly curved Inlet lower end and counterpart PPLD band rounded lowest 7′ to 7 form compares with FIG. 20 less curved Inlet lower end and counterpart PPLD crescent form 7′ to 7. Said Sets include respective Filler Members 344, 141 with key 144, gasket 105 assembly of threaded Plug 4, swivel handle 107, with capped Flush Apparatus 10 assembly major nozzle 405.

FIG. 21 and FIG. 22 show said side elevation views of Angled Globose inverse: Centric Set 11CC and Sidelong Set 11 C, respectively. See same genres' details in prior Sets and said pgs on pg 41.

FIG. 23 and FIG. 24 show said side elevation view of Globose-inverse Low PAP Angle Sidelong,

Set 11CA and Globose Low PAP Angle Centric Set, 11BC, respectively. Each Set Inlet includes said upright upper portion, with GC spout comprising permanent retention fluids short height and said cylindrical forms globose Set; said Sets low PAP Line respective angles approach optimally minimal 118°, 117°. An Inlet End is shown in an anti-sidelong offset disposition; mostly upright Inlets disposed above basin lowest surfaces, in sidelong dispositions, comprise Sets that reside in domains of Fluid Elements and are planned; also, see genres of prior Sets with said pgs on pg 41.

Dual Sidelong Hybrid Circumferential Set 10A*, FIG. 25 shows with Partition 57 with embedded 53 Fin FESD with Flush Apparatus parts. PPLD bands and PAP Lines, one of each, on each side of said Partition embedded Fin as Partition-Fin FESD forms constitute two PPLD bands 7*, each with very narrow widths, from two elongated toward outlet rounded lowest PPLD forms, merged into common 7*′ form by Partition Lower Window 62. Partition-Fin FESD forms constitute said End 2 FESD forms of said circumferential Hybrid, with the same said circumferential genres and said lower conduit short height 17 and shorter 17′ PAP Line PPLD band separation, on each side of Partition comprising Trough FESD forms with respective PAP 47* Line. Partition Upper 59A Window rounded form is side truncated by an Upright Ridge 317, which ends to continue on side of Window 62, as said Troughs, Partition FESD forms part. Sets FESD forms and energy genres are universal across domains; four Flush Apparatus capped tie-ins and parts FIG. 29-31 describes.

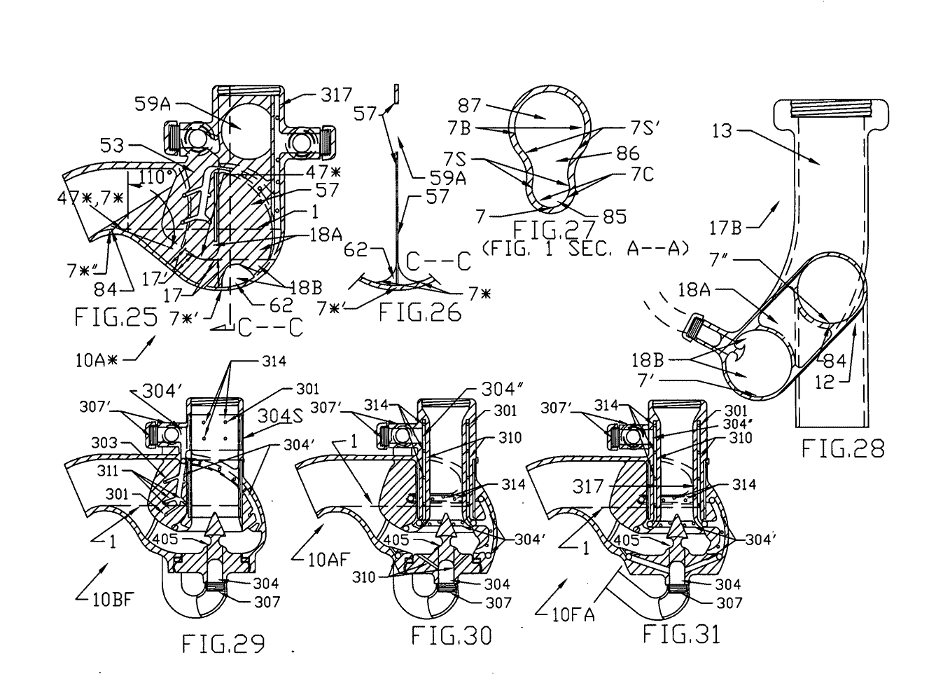

FIG. 26 shows Line C-C section of FIG. 25 Partition 57 FESD forms through Lower 62 and Upper 59A Windows FESD forms, with edges as previously described, with PPLD band lowest 7*′ and next to lowest 7*′ forms and raised basin lowest surface rounded into said Partition FESD forms.

FIG. 27 shows first Fluid Element cross-section forms, for illustration purposes, emphasizing said differences from the prior art entirely rounded forms. In the prior art, fluid ND compositions and fluids flow dynamics and energy utilized consume excessively light fluids and energy, especially since said light fluids are a significantly homogeneous commodity, which fluid forms and energy genres summary in said pgs on pg 41 describe. Said cross-section comprises lowest and smallest 85 of three cross-sectional composite areas, comprising optimally narrow complete complements of breadths of a rounded form that with narrow breadths raise centroid of highest specific gravity fluids. In said second Fluid Element said form referred to as lower conduit. Transition region 86 extends from lower 85 conduit springing 7C points elevation to globose wide forms rounded area 87 springing points 7B. This cross-sectional areas composite form is distinctive signature, if you will, genus Fluid Element DNA, apparent in second Fluid Elements GC cross-sectional areas and first Fluid Element forms perimeter constituted genres, essentially mandatory DCSS FESD forms forced fluids optimally low and steady pressure; Earth magnetic field cusps and plasma fountains show same genres, with the atmosphere sustaining optimally steady pressures; all said genres are indeed universal. First Element PPLD band 7 and PAP Line constitute almost parallel and never coincident optimally low slopes. The closes that second Fluid Elements can come to PPLD, PAP genres is at best a close approximation of variables and functional differences, illustrated by Sets. Said cross-sectional areas wider breadths lower centroid of light specific gravity fluids, enforcing said two centroids optimally narrow separation enforcing light fluids optimal conservation and/or high specific gravity fluids optimal transport, genre identical with PPLD band and PAP Line said separations; flow velocities restricting wider breadths force said complete compliments of forms.

Fundament circumferential strain second Fluid Element Set 17B forms show.

Flush Apparatus assemblies that rinse, flush, and disinfect, and protect or repair deterioration and wear of surfaces Set 10BF, 10AF, 10FA FIGS. 29-31 shows; FIGS. 4, 7, 11, 12, 19-25, 28-31 and 32 also show Flush Apparatus assemblies, tie-in 10 to major nozzle 405 most and not all of which comprise Cap or Plug of basin lowest surface access Portal. Flush Apparatus are entirely inside conduit walls, but for tie-ins, and are capable said functions, specifically Inlet with basin outlet lowest surfaces PPLD band widths and entire length. Flush Apparatus assemblies are pre-molded pre-assembled for designed liquid or gas and/or air supplied under controlled pressures to tie-in or tie-ins, disposed for access. Sub-nozzles 301, sub-passageways 303, major nozzles 405, major passageways 304 304′ 304″ 304S, passageways 310 and respective branches set 307′ of tie-ins 307, set of sub-passageways branches 311 and sub-nozzles set 314 are available parts selectively pre-assembled. Flush Apparatus parts numerous assemblies inside conduit walls are simplified by molded fabrication. A tie-in or a set of tie-ins is only outstanding part from a conduit wall and receives its pre-selected design fluid(s) under pre-selected pressures to designated nozzles. A specific shape passageway, such as in upright Ridges FESD, FIG. 25, 29-31, double wall inner space 304S passageway FIG. 29-31 depicts. A major nozzle 405 for a respective major passageway is spray type that flushes entire basin lower lowest surface and into an outlet and lower Inlet. FIG. 29 upper Inlet illustrates double wall passageway 304S, sub-nozzles set 314, and nozzles 301, and a lower Inlet and a basin passageway set 304′, and sub-nozzles 301. Shown Fin FESD form includes a sub-passageway 303 set 311, and sub-nozzles. FIG. 30 shows two FESD Ridges extended for an entire Inlet height, wherein said upright PAP plane aligns a passageway 310, a set of sub-nozzles 314, and major passageway rings inside lower Inlet walls with sub-nozzles sets 314. Assemblies comprise said parts illustrated as inclusive, including said Plug or Cap assembly with nozzle 405.

FIG. 32 shows Globose Cylindrical Industrial Centric hybrid 10′ Set that functions in very low to very high hydrostatic pressures. Set forms comprise large retention and huge detention volumes, yet belong within said GC domains of forms. With a universal joint comprising said End 1, Inlet forms easily rotate into wide range of rotated forms desired angle Set, comprising outlet 12 three Sub-outlets—First Sub-outlet 85 with summit 84, Second Sub-outlet 85 and Third Sub-outlet 36. Herein shown, with upright Inlet 13, Holding Chamber 12A retention free surface above summit 84 makes fluid free surface one form upper retention that subdues fluids oscillation dynamics. A further rise in fluids level adds to basin upper retention mass that opposes fluids oscillation. Said Sub-outlets prioritize high specific gravity fluids transport through First Sub-outlet, which cannot experience back pressures higher than its flow pressures. Said Chamber with air inflow one-way nozzle, at highest elevation, or a connection to a venting stack provides a backup against suction;

Said Industrial Set constitutes FIG. 2-3 Set upright axes magnified several times. Conversely, said Industrial Set shrunk in height, Sub-outlets merged into FIG. 27 cross-section forms and complete complements of configured forms constitute FIG. 2-3 Set. FIG. 1, Fluid Elements parent has it all.

What is claimed is:

1. An advanced Processor couples the Earth's magma and mantle magnetic field functions, and couples mantle quanta masses vital groundwater, polar caps and glaciers, less couples continental waters and oceans, partially decoupling atmosphere, and least coupling the ionosphere mass with electrons; mantle crustal mass density discontinuity boundaries restrict heat and electrical energy transfers, which decelerate the Earth's mantle, atmospheric fluids gaseous boundaries distending, and magnetic field weakening and Fluid Elements mass energy highest conserving quintessential core natural dispositions (QCNDMEHC) embody functions configured complete compliments of boundaries longevity forms, forms least energy of distortion volume changes, with stratifications gradations forbidden mechanisms forced plasma outflows; an optimally diatomic atmosphere and fluids composition MEHC genres embody God's forms constituted Fluid Elements, Isotopes, and Ions principles, methodologies, innovations and inventions (FEIIPMII) technologies mass energy demand sustained en masse minima; forcing fluids mass conserving processes that exceed energy demands, natural and anthropogenic global warming (AGW), constitute this civilization's option; said advanced Processor functioning constituted magnetosphere enormous distortions, in volume and boundaries, constitute Fluid Elements crucially deformable boundaries that confront cosmic, especially solar, radiations and wind pressures with Black Holes suction killing energy demands.

2. An advanced Processor boundaries magnetic field functions shielded fluids volume distortions and mass energy transfers, forced natural with unnatural air warming phenomena, with triatomic, higher multi-atomic gas molecules, greenhouse gases and water vapors forced partial decoupling from a cooling mantle into a surrounding atmosphere, fill diatomic nitrogen and oxygen rounded molecules interstitial voids; a saturated atmosphere low porosities retain radiation and irradiation heat energy; raised atmospheric temperatures increase water evaporation rates; in perpetual cycle causal effects, decoupled masses buoyancy forces water vapors mass into higher altitudes, below an ozone layer, created under solar radiations, from water vapor molecules broken apart into ions of hydrogen and oxygen, which along with nitrogen ions in forbidden mechanisms escape from a magnetic field light fluids gravity sink; in decoupling processes, energy of distortion and volume changes, including molecules breakup, distend fluids mass volume of a magnetosphere boundary and force stratifications and gradations forbidden mechanisms plasma fountains energy outflows.

3. A gravity sink and an electromagnet field mass energy retained fluids can not decouple from a mass energy enormous demand of the Universe, Milky Way Galaxy celestial bodies gravity sinks mass energy fields, and Black Hole suctions; said electromagnetic field lines fluid masses cannot avoid constellatory radiations and wind pressure effects; a planet's surfaces with solidified fluids as a phonographic record of magma displacements, and polar ice caps, glaciers, and groundwater partial decoupling changes with solidified mantle gradation and stratification processes recording erosional features, nearly eternal geologic history, that supplement a globose conduit (GC) offset inverse magnetosphere boundaries current period forms Set, mass energy effects constitute these: a) splitting triatomic molecules, air temperature rises with Jean's fountain plasma losses to space; b) a planet constituting said advanced Processor GC Fluid Elements electromagnetic field, with a magnetosphere constituting ionosphere distending boundaries enforced fluid fountains mass with energy outflows; c) the Processor's mantle cooling, crusting forced light fluids energy processes, forcing seismic events energy of volume changes and distortions, with magnetic field weakening.

4. A fluids composition functions conforming globose least quanta compact composite with free-surfaces at highest elevation, said quanta a globose conduit perimeter boundaries a Set and forms a least length least rotations and a least volume surfaces constitute said quanta fluids least energy fluids outflow, comprising an advanced Processor least coupled light fluids optimal densities that optimally retain said Set free surfaces perimeter boundaries of its fluids energy GC forms—Fluid Elements; said quanta conforming least mass boundaries evolving fluids energy constitutes Fluid Elements, Isotopes, and Ions, fluids advanced Processor generic Sets, a radially serial boundaries energy, comprising a uniquely superimposed a magnetic field and a gravity sink lowest potential.

5. The advanced Processor of claim 1, wherein the magnetic field shielded quanta mass functions include: the advanced Processor's Fluid Elements, Isotopes, and Ions and living organisms fluids mass densities, magnetic field lines magnetic poles two cusps inverted from inside its ionosphere and electrically charged stratosphere and upper atmosphere; the two cusps embody generic forms of electromagnetic field lines of a GC globose inverse offset centric Set, with an open mouth two Inlets interchangeable with an orifice two outlets or interchangeable an orifice outlet and an open mouth Inlet, as interchangeable parts of said advanced Processor deformed perimeter boundaries.

6. The advanced Processor of claim 1, comprising magnetic field shielded quanta mass functions continuum dynamics force gravitational field and atmosphere's essentially stable, energy benign, offset centric Globose Inverse Set, in blow offs migrating into an energetic Globose Sidelong Set globose forms changes, with the Black Hole's stratifications, gradations fluid functions enforcing lowest mass energy potential levels and magnetopause's enormous distortion enforced by suction at magnetic field cusp shoulder, and thus partial or significant atmospheric mass energy blow off.

7. The advanced Processor of claim 1, comprising magnetic field shielded quanta mass functions by Fluid Elements sustainable processes, with super green nuclear super plant slurry walls sealed buried thermal aqueducts, irrigation distended groundwater boundaries, and precipitation warmer and groundwater cooler energy coupling reverse said distending gaseous boundaries fluid energy decoupling, by enforcing coupled and partly decoupled mass energy paths into the Earth's crustal boundary; the Earth crustal boundary retains most of internal electrical and heat energy transfers, lessening gaseous fluids boundary distending and said Earth's cooling magnetic field weakening; said FEIIPMII civilization's lone recourse comprises Fluid Elements minimal fluids mass energy demand science technologies sustainable solutions, global warming and energy crisis combat and en masse water conserving, that together must arrest natural with anthropogenic global warming.

8. The advanced Processor of claim 1, comprising magnetic field shielded quanta mass functions said FEIIPMII and universal GC Sets and SP combat, oppose scramble, stratifications gradations forbidden mechanisms processes; consequently the Earth's strongest magnetic field is a must do; Black Holes' mass energy streaming demands, MEHC, and magnetic and gravitational fields rule the Universe with densest mass energy densities dominating at confronting perimeter boundaries, and thus gravity mass energy sinks, minima maxima—conforming least mass MEHC—functions forcing forms equal functions—functions equal forms, evolving globose spherical celestial bodies. Said fountains light fluids plasma outflows, through magnetic field cusps, pay with highly valued commodities—nitrogen and water based ions that constitute outflows plasma; strongest magnetic field, and gravity sink, least volume ionosphere light fluids densest boundaries are a forced must; said GC Sets with SP buried thermal aqueducts, strategic heat energy transfers, technologies with said FEIIMII, constitute only means for a strong magnetic field and this civilization only options.

9. The advanced Processor of claim 1, constituted magnetic field shields quanta mass functions Fluids' conservations MEHC constituted fluid functions with boundaries optimal longevity force fluids least mass functions least energy of distortion and volume change; causal effects evidence, frozen status of a planet more distant from the Sun than the Earth, and additionally in FEIIPMII a magnetic field functions relevance, reveal water mass, AGW, and natural global warming energy crises; said FEIIPMII energy of distortion longevities least rate of failures comprise water vapors least decoupling, as the SP aqueducts heat energy transfers remove crucial triatomic water vapors from the atmosphere, constituting electrical energy generation minimal AGW; all that constitutes optimally controlled diatomic atmosphere forced climate control; said aqueducts added irrigation functions transfer atmospheric water vapors into groundwater mass coupled to the mantle's crust; water coupling mass energy transfers, enforcing continental crust expansion, hinder volcanic and tectonic events and cooling mantle coupled to least coupled mass energy abrupt volume changes.

10. A quanta conforming least mass fluids composition that comprises a highest elevation, a least height, fluids globose volume least length compact composites naturally free surfaces and quanta mass energy least rotations, GC Universe a least height boundary and minima surfaces, optimally conserve fluids energy; a conforming embodiment, a quintessential core natural disposition mass energy highest conserving (MEHC), a genome, compact composite of forms completely matched complete complements constitute a GC Set, a Fluid Element, forming an inflow Inlet, a basin and an outlet, enclosing fluids said quanta, whose fluids flow comprises quantum concurrent paths of passage (PP) with a lengths least sum, a PPLLS, constituting a path angle of passage, a PAP line, and a basin outlet lowest surfaces path, a path of passage of least energy demand, a PPLD, with a PPLD band width with PPLD forms, and fluids an upper retention submerged an Inlet lower end, a globose End 2, or a globose inverse First End undersurface, in a transition region; said Inlet has an upper end, an End 1, a lower end, said End 2, or ends in a Set basin form that houses said First End; said Inlet End 2 or said outlet First End fluid outflows comprise said fluids quantum masses steady transports, along optimally short height and length slopes, narrow width PPLD bands, and conduit breadths embodied forms complement; manipulated cross-sections varied areas complete complement breadths force highest densities fluids highest elevations, ahead of said fluids quanta globose conforming least mass, large free surfaces and under uniform atmospheric and restrained hydrostatic pressures fluids dynamic flows; a quanta fluid higher densities transporting, with said forms raised fluids centroids, constitute said forms and least length, a short right-of-way, through at least three manipulated cross-sections, modulating areas; a Set complete complement breadths, constitute complete globose open channel large free-surface forms of least perimeter, height, and quanta mass rotations, a PAP Line angle less than 180°, and a Flush Apparatus maintained FESD forms; globose conduit functions make a much smaller fluids quanta said Set or forms than those of the prior art; said End 2 or First End a sidelong to an anti sidelong locality creates domain and Sets; crossing a globose with a circumferential strain effects a hybrid domain; GC forms, globose composite complete complement breadths enclose a first Fluid Element, a lower conduit, a wider transition region, with globose cross-sections upper forms yet wider breadths; a Flush Apparatus, parts pre-molded in walls, adeptly flush, sterilize and/or coat surfaces; said (GC) globose conduit Universe forces natural disposition Sets infinitesimal to infinite quintessential, core, mass energy highest conserving (QCMEHC) conforming, functional two globose and conforming two conduit fluids quanta mass energy unique perimeters, synchronous four perimeters complete complement coincident boundaries, two genomes rudimentary Fluid Elements analogous to Atomic Elements; universal MEHC genres embodied analogies, with atomic elements, applied to nonhomogeneous, nonuniform and unsteady fluids, specified and illustrated said Sets, forms, and domains describe.
